(19) United States
(12) Patent Application Publication
(10) Pub. No.: US 2024/0427005 A1
(43) Pub. Date: Dec. 26, 2024

(54) BACKSCATTER BASED POSITIONING

(71) Applicant: QUALCOMM Incorporated, San Diego, CA (US)

(72) Inventors: Mohammad Tarek Fahim, San Diego, CA (US); Srinivas Yerramalli, San Diego, CA (US); Jing Sun, San Diego, CA (US)

(21) Appl. No.: 18/338,343

(22) Filed: Jun. 20, 2023

(51) Int. Cl. G01S 13/74; G01S 13/75; G01S 13/76; H04W 64/00

(52) U.S. Cl. CPC G01S 13/74; G01S 13/751; G01S 13/767; H04W 64/00

(57) ABSTRACT

This disclosure provides systems, methods, and devices for wireless communication that support backscatter based positioning. In a first aspect, a method of wireless communication includes receiving, from a transmit network entity, a data signal via a first channel. The method also includes receiving, from a tag device, a backscatter signal based on the data signal received by the tag device via the first channel. The backscatter signal is received via a second channel that is different from the first channel. The method further includes transmitting a report that indicates a position measurement associated with a position of the tag device. The position measurement is determined based on the received data signal and the received backscatter signal. Other aspects and features are also claimed and described.

### TECHNICAL FIELD

Aspects of the present disclosure relate generally to wireless communication systems, and more particularly, to backscatter based positioning. Some features may enable and provide improved communications, including reduced control overhead, efficient resource utilization, improved network access, improved ranging measurements, enhanced location determinations, more efficient transmission/reception point (TRP) selection, reduced interference, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Radio frequency identification (RFID) systems and devices usually include a reading device, called a reader, and one or more tag devices, referred to as RFID tag devices or tag devices. The reader may correspond to a transmission reception point (TRP) or a user equipment (UE). The tag device typically includes a wireless microchip used to tag an object for automated identification. However, the use of tag devices has not been has not been applied to current 3GPP technologies and Internet-of-Things (IoT) implementations that may include identification, monitoring, positioning, and tracking, as illustrative, non-limiting examples. Accordingly, use of tag devices applied to current 3GPP technologies, such as coexistence with UEs and infrastructure in frequency bands for current 3GPP technologies, has yet to be established. Given the low power and limited processing capabilities of different types of tag devices, incorporation of tag devices with 3GPP technologies presents a variety of complex technical challenges, such as limiting network congestion, overhead, and interference associated with the use of tag devices with 3GPP technologies.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication performed by a receive network entity includes receiving, from a transmit network entity, a data signal via a first channel. The method also includes receiving, from a tag device, a backscatter signal based on the data signal received by the tag device via the first channel. The backscatter signal is received via a second channel that is different from the first channel. The method also includes transmitting a report that indicates a position measurement associated with a position of the tag device. The position measurement is determined based on the received data signal and the received backscatter signal.

In an additional aspect of the disclosure, receive network entity includes a memory storing processor-readable code, and at least one processor coupled to the memory. The at least one processor is configured to execute the processor-readable code to cause the at least one processor to receive, from a transmit network entity, a data signal via a first channel. The at least one processor is further configured to execute the processor-readable code to cause the at least one processor to receive, from a tag device, a backscatter signal based on the data signal received by the tag device via the first channel. The backscatter signal is received via a second channel that is different from the first channel. The at least one processor is further configured to execute the processor-readable code to cause the at least one processor to transmit a report that indicates a position measurement associated with a position of the tag device. The position measurement is determined based on the received data signal and the received backscatter signal

In an additional aspect of the disclosure, an apparatus includes means for receiving, from a transmit network entity, a data signal via a first channel. The apparatus further includes means for receiving, from a tag device, a backscatter signal based on the data signal received by the tag device via the first channel. The backscatter signal is received via a second channel that is different from the first channel. The apparatus also includes means for transmitting a report that indicates a position measurement associated with a position of the tag device. The position measurement is determined based on the received data signal and the received backscatter signal.

In an additional aspect of the disclosure, a non-transitory computer-readable medium stores instructions that, when executed by a processor, cause the processor to perform operations. The operations include receiving, from a transmit network entity, a data signal via a first channel. The operations further include receiving, from a tag device, a backscatter signal based on the data signal received by the tag device via the first channel. The backscatter signal is received via a second channel that is different from the first channel. The operations also include transmitting a report that indicates a position measurement associated with a position of the tag device. The position measurement is determined based on the received data signal and the received backscatter signal.

In an additional aspect of the disclosure, an apparatus includes a communication interface configured to receive, from a transmit network entity, a data signal via a first channel. The communication interface is further configured to receive, from a tag device, a backscatter signal based on the data signal received by the tag device via the first channel. The backscatter signal is received via a second channel that is different from the first channel. The apparatus further includes at least one processor coupled to a memory storing processor-readable code. The at least one processor is configured to execute the processor-readable code to cause the at least one processor to generate a report that indicates a position measurement associated with a position of the tag device. The position measurement is determined based on the received data signal and the received backscatter signal.

In an additional aspect of the disclosure, a method for wireless communication performed by a location management function (LMF) includes transmitting, to a first network entity and a second network entity, tag information associated with a tag device. The second network entity is configured to activate the tag device based on the tag information. The method also includes receiving, from the first network entity, a report that includes a position measurement indicating a position of the tag device. The position measurement is based on a data signal received by the first network entity from the second network entity via a first channel, and a backscatter signal received by the first network entity from a tag device via a second channel. The backscatter signal is based on the data signal. The method also includes identifying a position of the tag device based on the report.

In an additional aspect of the disclosure, an LMF includes a memory storing processor-readable code, and at least one processor coupled to the memory. The at least one processor is configured to execute the processor-readable code to cause the at least one processor to transmit, to a first network entity and a second network entity, tag information associated with a tag device. The second network entity is configured to activate the tag device based on the tag information. The at least one processor is further configured to execute the processor-readable code to cause the at least one processor to receive, from the first network entity, a report that includes a position measurement indicating a position of the tag device. The position measurement is based on a data signal received by the first network entity from the second network entity via a first channel, and a backscatter signal received by the first network entity from a tag device via a second channel. The backscatter signal is based on the data signal. The at least one processor is also configured to execute the processor-readable code to cause the at least one processor to identify a position of the tag device based on the report.

In an additional aspect of the disclosure, an apparatus includes means for transmitting, to a first network entity and a second network entity, tag information associated with a tag device. The second network entity is configured to activate the tag device based on the tag information. The apparatus further includes means for receiving, from the first network entity, a report that includes a position measurement indicating a position of the tag device. The position measurement is based on a data signal received by the first network entity from the second network entity via a first channel, and a backscatter signal received by the first network entity from a tag device via a second channel. The backscatter signal is based on the data signal. The apparatus also includes means for identifying a position of the tag device based on the report.

In an additional aspect of the disclosure, a non-transitory computer-readable medium stores instructions that, when executed by a processor, cause the processor to perform operations. The operations include transmitting, to a first network entity and a second network entity, tag information associated with a tag device. The second network entity is configured to activate the tag device based on the tag information. The operations further include receiving, from the first network entity, a report that includes a position measurement indicating a position of the tag device. The position measurement is based on a data signal received by the first network entity from the second network entity via a first channel, and a backscatter signal received by the first network entity from a tag device via a second channel. The backscatter signal is based on the data signal. The operations also include identifying a position of the tag device based on the report.

In an additional aspect of the disclosure, an apparatus includes a communication interface configured to transmit, to a first network entity and a second network entity, tag information associated with a tag device. The second network entity is configured to activate the tag device based on the tag information. The communication interface is also configured to receive, from the first network entity, a report that includes a position measurement indicating a position of the tag device. The position measurement is based on a data signal received by the first network entity from the second network entity via a first channel, and a backscatter signal received by the first network entity from a tag device via a second channel. The backscatter signal is based on the data signal. The apparatus further includes at least one processor coupled to a memory storing processor-readable code. The at least one processor is configured to execute the processor-readable code to cause the at least one processor to identify a position of the tag device based on the report.

In an additional aspect of the disclosure, a method for wireless communication performed by a transmit network entity includes receiving, from an LMF, tag information associated with a tag device. The method also includes transmitting, to a tag device and to a receive network entity, a data signal. The data signal transmitted via a first channel. Tag device is configured to transmit, to the receive network entity on a second channel, a backscatter signal based on the data signal. A position of the tag device is indicated by the data signal and the backscatter signal.

In an additional aspect of the disclosure, a transmit network entity includes a memory storing processor-readable code, and at least one processor coupled to the memory. The at least one processor is configured to execute the processor-readable code to cause the at least one processor to receive, from an LMF, tag information associated with a tag device. The at least one processor is further configured to execute the processor-readable code to cause the at least one processor to transmit, to a tag device and to a receive network entity, a data signal. The data signal transmitted via a first channel. Tag device is configured to transmit, to the receive network entity on a second channel, a backscatter signal based on the data signal. A position of the tag device is indicated by the data signal and the backscatter signal.

In an additional aspect of the disclosure, an apparatus includes means for receiving, from an LMF, tag information associated with a tag device. The apparatus further includes means for transmitting, to a tag device and to a receive network entity, a data signal. The data signal transmitted via a first channel. Tag device is configured to transmit, to the receive network entity on a second channel, a backscatter signal based on the data signal. A position of the tag device is indicated by the data signal and the backscatter signal.

In an additional aspect of the disclosure, a non-transitory computer-readable medium stores instructions that, when executed by a processor, cause the processor to perform operations. The operations include receiving, from an LMF, tag information associated with a tag device. The operations further include transmitting, to a tag device and to a receive network entity, a data signal. The data signal transmitted via a first channel. Tag device is configured to transmit, to the receive network entity on a second channel, a backscatter signal based on the data signal. A position of the tag device is indicated by the data signal and the backscatter signal.

In an additional aspect of the disclosure, an apparatus includes a communication interface configured to receive, from an LMF, tag information associated with a tag device. The apparatus further includes at least one processor coupled to a memory storing processor-readable code. The at least one processor is configured to execute the processor-readable code to cause the at least one processor to generate, for transmission to a tag device and to a receive network entity, a data signal. The data signal transmitted via a first channel. Tag device is configured to transmit, to the receive network entity on a second channel, a backscatter signal based on the data signal. A position of the tag device is indicated by the data signal and the backscatter signal.

In an additional aspect of the disclosure, a method for wireless communication performed by a tag device includes receiving a data signal on a first channel. The method also includes transmitting a backscatter signal on a second channel, distinct from the first channel. The backscatter signal is generated based on the data signal.

In an additional aspect of the disclosure, a tag device includes a memory storing processor-readable code, and at least one processor coupled to the memory. The at least one processor is configured to execute the processor-readable code to cause the at least one processor to receive a data signal on a first channel. The at least one processor is further configured to execute the processor-readable code to cause the at least one processor to transmit a backscatter signal on a second channel, distinct from the first channel. The backscatter signal is generated based on the data signal.

In an additional aspect of the disclosure, an apparatus includes means for receiving a data signal on a first channel. The apparatus further includes means for transmitting a backscatter signal on a second channel, distinct from the first channel. The backscatter signal is generated based on the data signal.

In an additional aspect of the disclosure, a non-transitory computer-readable medium stores instructions that, when executed by a processor, cause the processor to perform operations. The operations include receiving a data signal on a first channel. The operations further include transmitting a backscatter signal on a second channel, distinct from the first channel. The backscatter signal is generated based on the data signal.

In an additional aspect of the disclosure, an apparatus includes a communication interface configured to receive a data signal on a first channel. The apparatus further includes at least one processor coupled to a memory storing processor-readable code. The at least one processor is configured to execute the processor-readable code to cause the at least one processor to generate a backscatter signal on a second channel, distinct from the first channel. The backscatter signal is generated based on the data signal.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports backscatter based positioning according to one or more aspects.

FIG. 4 is a diagram illustrating backscatter based positioning according to one or more aspects.

FIG. 5 is a diagram illustrating backscatter based positioning according to one or more aspects.

FIG. 6 is a ladder diagram illustrating backscatter based positioning according to one or more aspects.

FIG. 7 is a flow diagram illustrating an example process that supports backscatter based positioning according to one or more aspects.

FIG. 8 is a flow diagram illustrating an example process that supports backscatter based positioning according to one or more aspects.

FIG. 9 is a block diagram of an example network entity that supports backscatter based positioning according to one or more aspects.

FIG. 10 is a flow diagram illustrating an example process that supports backscatter based positioning according to one or more aspects.

FIG. 11 is a block diagram of an example core network that supports backscatter based positioning according to one or more aspects.

FIG. 12 is a flow diagram illustrating an example process that supports backscatter based positioning according to one or more aspects.

FIG. 13 a block diagram of an example core network that supports backscatter based positioning according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support backscatter based positioning. For example, the present disclosure describes that a communication operation and a positioning operation may be conflated so that, while performing a communication operation, a network entity also may be configured to perform a positioning operation configured to identify a position of a tag device. To illustrate, as part of a communication operation, a first network entity, referred to as a transmit network entity, may transmit a data signal modulated with data. In particular, the first network entity may transmit the data signal, such as in a broadcast, over a first channel, referred to as a data channel. A second network entity, referred to as a receive network entity, may receive the data signal. Additionally, a tag device also may receive the data signal. The tag device may be configured to generate a backscatter signal in response to receipt of the data signal, and the tag device may be configured to transmit the backscatter signal. The second network entity may receive the backscatter signal via a second channel, also referred to as a backscatter channel. Based on the data signal and the backscatter signal, the second network entity may be configured to generate positioning information that includes a position measurement associated with the tag device. A position of the tag device may be determined based on the position measurement.

Particular implementations of the subject matter described in this disclosure may be implemented to realize one or more of the following potential advantages or benefits. In some aspects, the present disclosure provides techniques for supporting backscatter based positioning. The techniques described reduce signaling overhead associated with performance of a positioning operation, thereby reducing computational resources, communication resources, power, or any combination thereof allocated to performing the positioning operation. To illustrate, in lieu of using a dedicated signal, such as a positioning reference signal (PRS), in a positioning operation, the disclosure deploys existing telecommunication data signals to both implement a communication operation and a positioning operation. Accordingly, the computational overhead, such as processing capacity and memory, that otherwise would be dedicated to generating the dedicated PRS is liberated, and may be deployed for other purposes. Additionally, or alternatively, communication resources, such as frequency and time, that otherwise would be allocated to perform the positioning operation, are conserved. In some implementations, power that otherwise would be allocated to generating and transmitting the dedicating PRS likewise is conserved. Accordingly, by conflating a communication operation with a positioning operation, resources are conserved.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

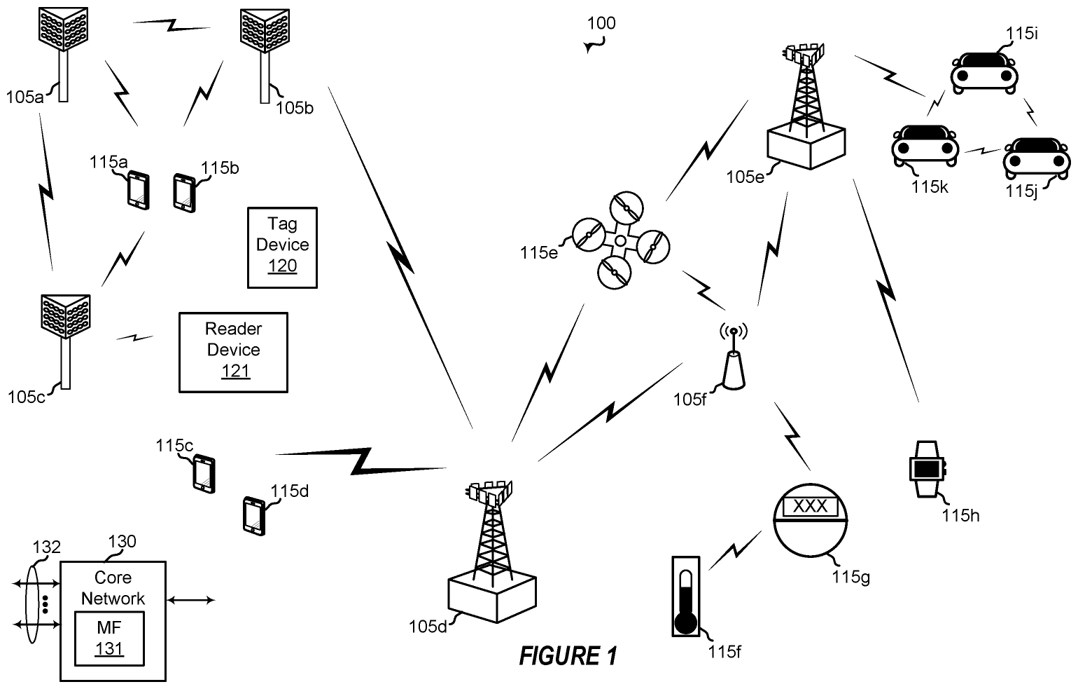

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c. Additionally, V2V mesh network may include or correspond to a vehicle-to-everything (V2X) network between UEs 115i-115k and one or more other devices, such as UEs 115x, 115y.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to management function (MF) 131, such as a Location Management Function (LMF), a Sensing Management Function (SnMF), or an Access and Mobility Management Function (AMF), which is an entity in the 5G Core Network (5GC) supporting various functionality, such as managing support for different location services for one or more UEs. The SnMF may be configured to manage support for sensing operations for one or more sensing operations or sensing services for one or more devices, such as one or more UEs 115, one or more base stations 105, one or more TRPs, or a combination thereof. For example the SnMF may include one or more servers, such as multiple distributed servers. Base stations 105 may forward sensing messages to the SnMF and may communicate with the SnMF via a NR Positioning Protocol A (NRPPa). The SnMF is configured to control sensing parameters for UEs 115 and the SnMF can provide information to the base stations 105 and UE 115 so that action can be taken at UE 115, base station 105, or another device. The LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via the AMF.

Tag device systems typically include tag device 120 and reader device 121. Tag device 120 includes an RFID device or tags that include a wireless microchip used for tagging objects for automated object identification. Reader device 121, such as an RFID reader, may be configured to transmit electromagnetic signals to other devices, such as tag device 120. Reader device 121 may include one or more processors and a memory and is typically able to process data. Additionally, reader device 121 usually includes one or more transmitters and receivers. For instance, reader device 121 may include or correspond to base station 105 or to UE 115. During typical operation, reader device 121 may be configured to transmit a signal, which is receivable by tag device 120, and to receive and process a signal from tag device 120 that is responsive to the transmitted signal. In implementations, tag device systems typically involve a plurality of tag devices (hereinafter referred to collectively as “tag device 120”) and a plurality of reader devices (hereinafter referred to collectively as “reader device 121”).

Tag devices, such as tag device 120, are categorized based on functionality or capability. For instance, tag device 120 may be categorized as one of a passive tag, a semi-passive tag, and an active tag depending on the functionality or capabilities of tag device 120. Accordingly, tag device 120 may correspond to a passive tag, a semi-passive tag, or an active tag.

Passive tags typically lack a power source, harvest energy from ambient electromagnetic signals, and have limited computational capacity, often lacking components, such as analog to digital converters (ADCs) and digital to analog converters (DACS) for signal processing. Since passive tags generally lack signal processing capability, passive tags typically include a simple circuit to reflect a received electromagnetic signal to the environment in the form of a backscatter transmission. For instance, reader device 121 may transmit an electromagnetic signal that a passive tag, such as tag device 120, may receive and at least partially reflect in the form of a backscatter signal. To elaborate, if tag device 120 is a passive tag then tag device 120 may include circuitry to at least partially reflect non-absorbed portions of electromagnetic signals received from the ambient environment, such as transmitted by reader device 121, in the form of a backscatter transmission.

Semi-passive tags usually include an on-board power source to provide energy for on-board electronic components. In general, semi-passive tags often have more computational power than passive tags. Additionally, semi-passive tags may have a limited on-board power source; however, semi-passive tags typically transmit signals through backscatter transmissions as explained above in the context of passive tags.

Active tags often include an on-board power source and more computational capacity than passive or semi-passive tags. Moreover, unlike passive and semi-passive tags that normally are unable to transmit unless a reader device, such as reader device 121, is in proximity to them, active tags are able to transmit regardless of a proximity of a reader device. Active tag devices typically include signal processing functionality, such as ADCs, DACs, and the like. Moreover, active tags often include a power source and are able to actively transmit. In particular, unlike passive and semi-passive tags that generate a backscatter signal by at least partially reflecting a transmission received from a reader device (e.g., reader device 121), active tags are capable of transmitting independently of a signal received from another device, such as reader device 121.

Additionally, tag devices, such as tag device 120, typically include a tag identification to uniquely identify the tag device. Accordingly, a tag device, such as tag device 120, may include its unique tag identification in response to receipt, at the tag device, of a transmission from reader device 121. If tag device 120 corresponds to a passive tag or a semi-passive tag, tag device 120 may be configured to at least partially reflect the transmission received from reader device 121 in the form of a backscatter signal that is readable by reader device 121. While an active tag is able to process a transmitted signal received from reader device 121, in some implementations, an active tag device may also partially reflect the received signal as a backscatter signal or may independently transmit a signal to reader device 121 in response to a signal received from reader device 121.

Tag device systems that include tag device 120 and reader device 121 may be deployed for positioning an object associated with tag device 120 through use of backscatter based positioning. For instance, tag device 120 may be affixed to an object, and reader device 121 may be configured to identify a position (e.g., a two-dimensional position, a three-dimensional position) of the object to which tag device 120 is affixed through use of backscatter based positioning. Accordingly, tag device systems can be deployed in a wide range of applications in which accurate and precise object positioning is achieved. These applications may include automated checkout, medical application such as monitoring patients' compliance with medical directives, and law enforcement and security applications, as illustrative, non-limiting examples.

In a typical backscatter based positioning operation, reader device 121 transmits an electromagnetic signal dedicated to performance of positioning operations, such as a positioning reference signal (PRS), and tag device 120 may at least partially reflect the electromagnetic signal as a reflected electromagnetic signal. For example, in response to receipt of an electromagnetic signal (e.g., a PRS at tag device 120), tag device 120 may be configured to generate a reflected electromagnetic signal, referred to as a backscatter signal. To elaborate, tag device may include simple circuitry that, in response to receipt of the transmitted electromagnetic signal (e.g., the PRS), generates (e.g., through resonance) an excitation signal that may be referred to as the backscatter signal.

In a monostatic positioning operation, reader device 121 that transmits the electromagnetic signal (e.g., PRS) also receives the at least partially reflected electromagnetic signal (e.g., the backscatter signal). In a bistatic positioning operation, a second reader device, distinct from reader device 121 that transmits the electromagnetic signal (e.g., the transmitted PRS), receives the at least partially reflected electromagnetic signal (e.g., the backscatter signal). The dedicated positioning signal, such as the PRS, usually is a RF signal, the parameters of which have been selected for backscatter-based positioning operations. These parameters may include a distinct bandwidth, amplitude range, modulation pattern, orthogonal frequency-division multiplexing (OFDM) symbol pattern, or any combination thereof.

Accordingly, backscatter-based positioning may involve at least one transmit (Tx) reader device 121; a tag device (e.g., a RFID tag such as tag device 120), a position of which is to be determined through application of backscatter-based positioning; and at least a second receive (Rx) reader device 121. However, one or more additional reader devices 121 may be deployed. Estimates of a position of tag device 120 are obtained by measuring a round trip time (RTT), which is the sum of a first amount of time for an electromagnetic signal, such as PRS, to propagate from Tx reader device 121 to tag device 120, a second amount of time for a backscatter signal to be reflected from tag device 120 to Rx reader device 121, and third amount of time indicating the tag delay. The tag delay corresponds to an amount of time that elapses for tag device 120 to process a received electromagnetic signal, such as PRS, and to at least partially reflect the received electromagnetic signal as a backscatter signal. The first amount of time for the electromagnetic signal, such as PRS, to propagate from Tx reader device (RD) 121 to tag device 120 may be denoted as τ_{RD_1→Tag Device}. The second amount of time for the backscatter signal to be reflected from tag device 120 to an at least Rx reader device 121 may be denoted as τ_{Tag Device→RD_x}, where the value of x denotes a first Rx reader device 121 (x=1), a second Rx reader device 121 (x=2), third Rx reader device 121 (x=3), and fourth Rx reader device 121 (x=4). The third amount of time attributable to tag delay may be denoted as τ_{Tag Delay}. For example, the amount of time for a backscatter signal to be reflected by tag device 120 to second Rx reader device may be denoted τ_{Tag Device→RD_2}, while the amount of time for the backscatter signal to be reflected by tag device 120 to fourth reader device 121 may be denoted as τ_{Tag Device→RD_4}. Accordingly, using the assumption that τ_{RD_1→Tag Device}=τ_{Tag Device→RD_1} and the equations below, a position of tag device 120 may be determined:

$${τ}_{RD \_ 1} = {τ}_{RD \_ 1 \to Tag Device} + {τ}_{Tag Device \to RD \_ 1} + {τ}_{Tag Delay} ,$$

$${τ}_{RD \_ 2} = {τ}_{RD \_ 1 \to Tag Device} + {τ}_{Tag Device \to RD \_ 2} + {τ}_{Tag Delay} ,$$

$${τ}_{RD \_ 3} = {τ}_{RD \_ 1 \to Tag Device} + {τ}_{Tag Device \to RD \_ 3} + {τ}_{Tag Delay} , and$$

$${τ}_{RD \_ 4} = {τ}_{RD \_ 1 \_ 1 \to Tag Device} + {τ}_{Tag Device \to RD \_ 4.} + {τ}_{Tag Delay} .$$

In particular, τ_{RD_1}, τ_{RD_2}, τ_{RD_3}, and τ_{RD_4} are RTT values that are used in time of arrival (ToA), time difference of arrival (TDoA), and angle of arrival (AoA) positioning techniques to obtain a position of a tag device (e.g., 120). For example, to implement ToA positioning, one or more devices, such as MF 131 of core network 130, may be configured to perform the following ToA positioning calculation:

$$\begin{matrix}{τ}_{Tag Device \to {RD}_{\_ 1}} = \frac{{τ}_{{RD}_{\_ 1}}}{2} , {τ}_{Tag Device \to {RD}_{\_ 2}} \\ = {τ}_{{RD}_{\_ 2}} - \frac{{τ}_{{RD}_{\_ 1}}}{2} , {τ}_{Tag Device \to {RD}_{\_ 2}} \\ = {τ}_{{RD}_{\_ 2}} - \frac{{T}_{{RD}_{\_ 1}}}{2} , {τ}_{Tag Device \to {RD}_{\_ 3}} \\ = {τ}_{R {D}_{\_ 3}} - \frac{{τ}_{{RD}_{\_ 1}}}{2} , {τ}_{Tag Device \to {RD}_{\_ 4}} \\ = {τ}_{RD \_ 4} - \frac{{τ}_{RD \_ 1}}{2}\end{matrix}$$

Similarly, to implement TDoA positioning, one or more devices, such as MF 131 of core network 130, may be configured to perform the following TDoA positioning calculation:

$$\begin{matrix}∇ {τ}_{i , ref} = {τ}_{Tag Device \to R {D}_{i}} - {τ}_{Tag Device \to {RD}_{ref}} \\ = {τ}_{i} - {τ}_{ref} ,\end{matrix}$$

in which RD_{ref} is a reference reader device and RDᵢ is another reader device.

In some implementations, one or more devices, such as MF 131, may be configured to determine an AoA through use of data included in measurement reports. To illustrate, one or more reader devices 121 may include directional antenna arrays and may be configured to determine an angle from which one or more backscatter signals are received. Hence, one or more reader devices 121 may include the angle of receipt of the one or more backscatter signals in a report transmitted to MF 131. MF 131 may then determine an AoA based on the angle of receipt data included in the one or more reports.

A data signal to perform wireless communication and to perform a positioning operation is disclosed herein. While backscatter-based positioning is useful in determining a position of tag device 120, use of dedicated signaling, such as PRS, in a positioning operation may be challenging. For example, computational resources of reader device 121 (e.g., processing capacity, memory, or both) may be allocated to generation of the dedicated signal (e.g., the PRS). For instance, parameters corresponding to generation of the dedicated signal, such as PRS, are stored in memory. Further, a processor may perform one or more calculations to generate the PRS parameters and to initiate transmission of PRS at a transmitter of reader device 121. Additionally, power may be consumed in generating and transmitting the PRS. Moreover, bandwidth that otherwise could be allocated to communication may be sacrificed to performance of positioning operations using dedicated signaling. Since the dedicated signal, such as PRS, is typically used exclusively for positioning operations, rather than to facilitate wireless communication, allocation of limited computational, power, and bandwidth resources to generate the dedicated signal, such as PRS, may be wasteful. Accordingly, rather than using a dedicated signal, such as PRS, to perform a positioning operation, a data signal to perform wireless communication and to perform a positioning operation is disclosed. Joint performance of data communication and positioning facilitates efficient spectrum usage and higher data communication throughputs while maintaining positioning accuracy and precision.

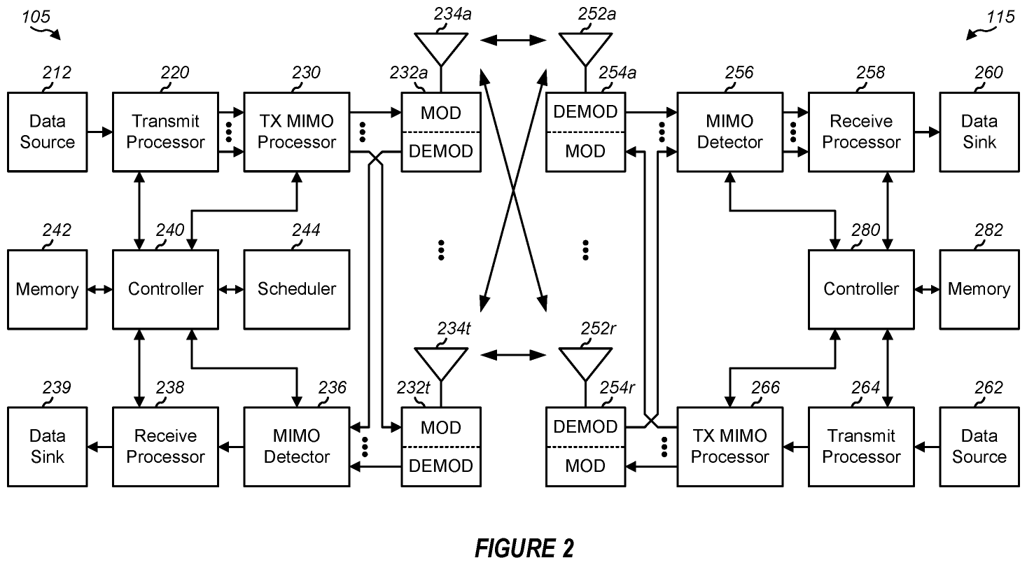

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

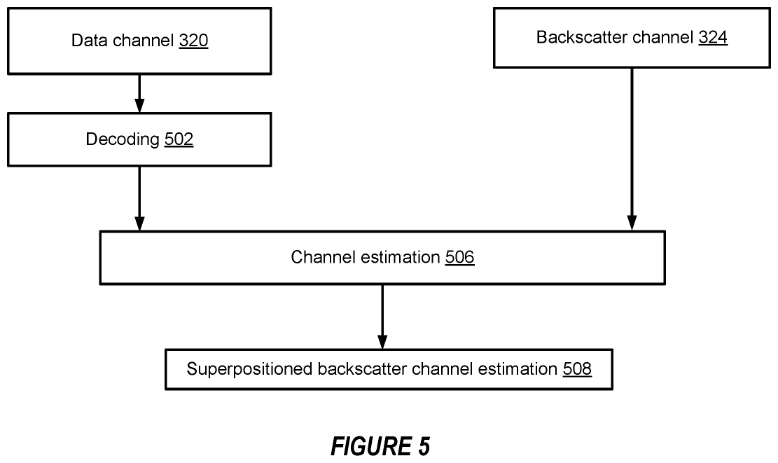

Controllers 240 and 280 may direct the operation at base station 105 and UE 115, respectively. Additionally, controllers 240 and 280 may direct the operation of core network 130, reader device 121 (e.g., a network entity operable as a reader device), or other devices. Controller 240 or other processors and modules at base station 105 or controller 280 or other processors and modules at UE 115 may perform or direct the execution of various processes for the techniques described herein, such as to perform or direct the execution illustrated in or described with reference to FIGS. 5-8, 10, and 12 or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

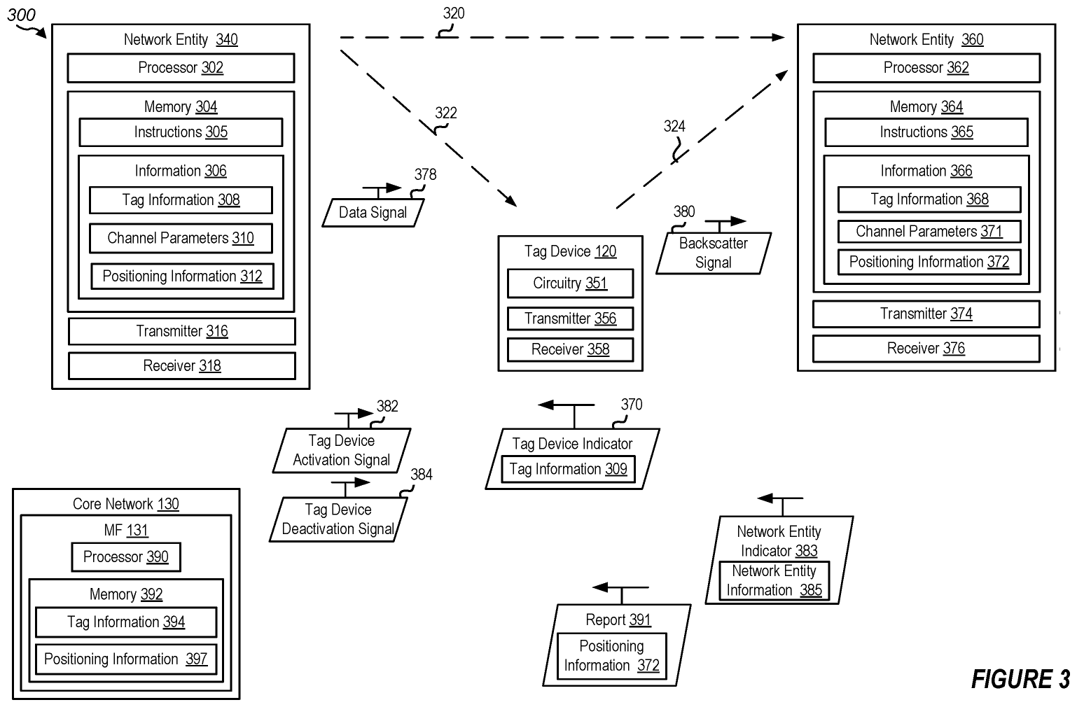

FIG. 3 is a block diagram of an example wireless communications system 300 that supports backscatter based positioning according to one or more aspects. In some examples, wireless communications system 300 may implement aspects of wireless network 100. Wireless communications system 300 includes network entity 340, network entity 360, tag device 120, and core network 130. Network entity 340, network entity 360, or both may include or correspond to reader device 121. As such, network entity 340 may be a Tx TRP (e.g., base station 105) and network entity 360 may be a Rx UE (e.g., UE 115). Alternatively, network entity 340 may be a Rx UE (e.g., UE 115) and network entity 360 may be a Tx TRP (e.g., base station 105).

Although two network entities 340, 360 are illustrated, in some other implementations, wireless communications system 300 may generally include multiple network entities. Additionally, although one tag device 120 is illustrated, in some implementations multiple tag devices may be deployed.

Network entity 340 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). In some implementations, network entity 340 may include an interface (e.g., a communication interface) that includes transmitter 316, receiver 318, or a combination thereof. Processor 302 may be configured to execute instructions 305 stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store instructions 305 and information 306. Instructions 305 may include processor-readable code, program code, one or more software instructions, or the like, as illustrative, non-limiting examples, each configured to implement the functionality described herein. Information 306 may include tag information 308, channel parameters 310, and positioning information 312.

Tag information 308 may include or correspond to a sensitivity indicator that indicates a sensitivity of tag device 120 to data signal 378 transmitted by the network entity 340, a group delay indicator that indicates a processing time incurred by tag device 120 to generate backscatter signal 380 based on data signal 378, capability information that indicates a capability of tag device 120 to shift a frequency of data signal 378, a tag identifier (e.g., uniquely identifying tag device 120), a bandwidth of backscatter signal 380, or a combination thereof. The tag identifier may include or correspond to any address, number, code, or the like suitable to uniquely identify tag device 120.

Channel parameters 310 may include or correspond to characteristics of data channel 320, 322, sometimes referred to herein as the first channel. These characteristics may include a first value corresponding to a first frequency of data channel 320, 322, a second value corresponding to a first bandwidth of data channel 320, 322, a third value corresponding to a path loss of the data channel 320, 322, or a combination thereof.

Positioning information 312 may include or correspond to one or more position measurements generated through performance of a positioning operation and determined based, at least in part, on backscatter signal 380. As explained below, while network entity 340 is depicted as a Tx network entity 340, network entity 340 may function as a Rx network entity 340, thereby receiving backscatter signal 380. Hence, when operating as a Rx network entity 340, memory 304 may include positioning information 312. Positioning information 312 may include a position measurement associated with a position of or indicating a position of tag device 120. For example, a position measurement included in positioning information 312 may include a ToA associated with backscatter signal 380. The ToA may correspond to a sum of a first quantity of time for data signal 378 to arrive at the tag device 120 via data channel 322 and a second quantity of time for backscatter signal 380 to arrive at network entity 360 via backscatter channel 324 (also referred to as second channel) minus a group delay associated with tag device 120.

Transmitter 316 is configured to transmit data signals such as data signal 378, reference signals, synchronization signals, control information, or any combination thereof to one or more other devices, and receiver 318 is configured to receive data signals such as data signal 378, reference signals, synchronization signals, control information, backscatter signals such as backscatter signal 380, or any combination thereof from one or more other devices. For example, transmitter 316 may transmit signaling, control information and data to, and receiver 318 may receive signaling, control information and data from, network device 360. Data signal 378 may be configured to carry data and backscatter signal 380 may include or correspond to an at least partially reflected data signal generated by tag device 120 in response to receipt, at tag device 120, of data signal 378.

In some implementations, transmitter 316 and receiver 318 may be integrated in one or more transceivers. Additionally or alternatively, transmitter 316 or receiver 318 may include or correspond to one or more components of base station 105 or UE 115 described with reference to FIG. 2.

In some implementations, network entity 340 may include one or more antenna arrays. The one or more antenna arrays may be coupled to transmitter 316, receiver 318, or a communication interface. The antenna array may include multiple antenna elements configured to perform wireless communications with other devices, such as with network entity 360. In some implementations, the antenna array may be configured to perform wireless communications using different beams, also referred to as antenna beams. The beams may include Tx beams and Rx beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of base station 105 or UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam. In some implementations, network entity 340 is a 5G-capable, 6G-capable, or a combination thereof.

Network entity 360 may include similar components to the components described with reference to network entity 340. For example, these components may include one or more processors 362 (hereinafter referred to collectively as “processor 362”), one or more memory devices 364 (hereinafter referred to collectively as “memory 364”), one or more transmitters 374 (hereinafter referred to collectively as “transmitter 374”), and one or more receivers 376 (hereinafter referred to collectively as “receiver 376”). In some implementations, network entity 360 may include an interface (e.g., a communication interface) that includes transmitter 374, receiver 376, or a combination thereof. Processor 362 may be configured to execute instructions 365 stored in memory 364 to perform the operations described herein. In some implementations, processor 362 includes or corresponds to one or more of receive processor 258, transmit processor 264, and controller 280, and memory 364 includes or corresponds to memory 282.

Memory 364 includes or is configured to store instructions 365 and information 366. Instructions 365 may include processor-readable code, program code, one or more software instructions, or the like, as illustrative, non-limiting examples, each configured to implement the functionality described herein. Information 366 may include tag information 368, channel parameters 371, and positioning information 372. Tag information 368 may include or correspond to tag information 308, and positioning information 372 may include or correspond to positioning information 312. Channel parameters 371 include or correspond to characteristics of backscatter channel 324, sometimes referred to herein as the second channel. These characteristics may include a first value corresponding to a frequency of backscatter channel 324, a second value corresponding to a bandwidth of backscatter channel 324, a third value corresponding to a path loss of backscatter channel 324, or a combination thereof.

Transmitter 374 is configured to transmit data signals such as data signal 378, reference signals, synchronization signals, control information, or any combination thereof to one or more other devices, and receiver 376 is configured to receive data signals such as data signal 378, reference signals, synchronization signals, control information, backscatter signals such as backscatter signal 380, or any combination thereof from one or more other devices. For example, transmitter 374 may transmit signaling, control information and data to, and receiver 376 may receive signaling, control information and data from, network device 340.

In some implementations, transmitter 374 and receiver 376 may be integrated in one or more transceivers. Additionally or alternatively, transmitter 374 or receiver 376 may include or correspond to one or more components of base station 105 or UE 115 described with reference to FIG. 2.

In some implementations, network entity 360 may include one or more antenna arrays. The one or more antenna arrays may be coupled to transmitter 374, receiver 376, or a communication interface. The antenna array may include multiple antenna elements configured to perform wireless communications with other devices, such as with network entity 340. In some implementations, the antenna array may be configured to perform wireless communications using different beams, also referred to as antenna beams. The beams may include Tx beams and Rx beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of base station 105 or UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam. In some implementations, network entity 360 is a 5G-capable, 6G-capable, or a combination thereof.

While network entity 360 is depicted as a Rx network entity 360, network entity 360 may operate as a Tx network entity 340. Accordingly, network entity 360 may be configured to perform analogous operations to network entity 340, just as network entity 340 may be configured to perform analogous operations to network entity 360. For example, while FIG. 3 depicts network entity 360 as receiving backscatter signal 380, network entity 360 may transmit data signal 373, and network entity 340 may receive backscatter signal 380.

In some implementations, wireless communications system 300 implements a 5G NR network. For example, wireless communications system 300 may include multiple 5G-capable network entities 340, 360 configured to operate in accordance with a 5G NR network protocol such as that defined by the 3GPP. In some other implementations, wireless communications system 300 implements a 6G network.

Tag device 120 may include a variety of components (such as structural, hardware components) used for carrying out one or more functions described herein. For example, these components may include circuitry 351, transmitter 356, and receiver 358. Circuitry 351 may include or correspond to energy harvesting circuitry, a microcontroller, one or more processors, a memory, an analog-to-digital converter (ADC), a digital to analog converter (DAC), an oscillator, or a combination thereof, as non-illustrative examples. The components of circuitry 351 may depend on whether tag device 120 is a passive tag, a semi-passive tag, or an active tag.

Circuitry 351 may be configured to generate backscatter signal 380 in response to receipt, at tag device 120, of data signa 378. For example, in some implementations, circuitry 351 may be activated (e.g. placed in an active or “on” state) in response to receipt of tag device activation signal 382. In an active state, circuitry 351 may be configured to generate backscatter signal 380 in response to receipt, by tag device 120, of data signal 378. Conversely, in an inactive state, circuitry 351 may not generate backscatter signal 380 in response to receipt, by tag device 120, of data signal 378. From being in an active state, circuitry 351 may be configured to transition to an inactive state in response to receipt, at tag device 120, of a tag device deactivation signal, such as tag device deactivation signal 384.

Transmitter 356 is configured to transmit one or more signals (e.g., backscatter signal 380 or data) to one or more other devices (e.g., network entity 340, 360). Receiver 358 is configured to receive one or more signals (e.g., data signal 378) from one or more other devices (e.g., network entity 340, 360). For example, receiver 358 may receive data signal 378 from network entity 340 and transmitter 356 may transmit backscatter signal 380 to network entity 360. As another example, receiver 358 may be configured to receive tag device activation signal 382, tag device deactivation signal 384, or both. In some implementations, transmitter 356 and receiver 358 may be integrated in one or more transceivers. Additionally, or alternatively, transmitter 356 or receiver 358 may include or correspond to one or more components of UE 115 described with reference to FIG. 2.

Tag device 120 may include one or more components as described herein with reference to tag device 120. In some implementations, tag device 120 is a 3GPP-capable tag device, an LTE-capable tag device, a 5G-capable tag device, a 6G-capable tag device, or a combination thereof.

Core network 130 may include a 3GPP core network, a 4G core network, a 5G core, or an evolved packet core (EPC). Core network 130 may be coupled, such as communicatively coupled, to one or more network entities, such as network entity 340, network entity 360, or both. Core network 130 may include MF 131, which may include correspond to an LMF.

Although shown and described as being included in core network 130, MF 131 may be distinct from core network 130 in some implementations. For example the MF 131 may include one or more servers, such as multiple distributed servers. MF 131 may be configured to support various functionality, such as managing support for different location services for one or more UEs, one or more tag devices, or one or more network entities. Network entities 340, 360, may forward location messages to MF 131 and may communicate with MF 131 via a protocol, such as a NR Positioning Protocol A (NRPPa). In some implementations, network entities 340, 360, tag device 120, or a combination thereof are configured to communicate with MF 131 via an Access and Mobility Management Function (AMF).

MF 131 may include a variety of components (such as structural, hardware components) used for carrying out one or more functions described herein. For example, these components may include one or more processors 390 (hereinafter referred to collectively as “processor 390”), one or more memory devices 392 (hereinafter referred to collectively as “memory 392”), one or more transmitters (not depicted), and one or more receivers (not depicted). In some implementations, MF 131 may include an interface (e.g., a communication interface) that includes the one or more transmitters, the one or more receivers, wired communication means, or a combination thereof. The interface may be configured to receive tag device indicator 370, report 391, or any combination thereof.

Processor 390 may be configured to execute instructions stored in memory 392 to perform the operations described herein. Processor 390 may include or corresponds to one or more of receive processor 258, transmit processor 264, and controller 280, and memory 392 may include or correspond to memory 282. Memory 392 may be configured to store tag information 394 and positioning information 397. Tag information 394 may include or correspond to tag information 308, tag information 309, tag information 368, or any combination thereof. Positioning information 397 may include or correspond to positioning information 312, positioning information 372, or any combination thereof. Processor 390 may be configured to determine a position of tag device 120 based on positioning information 397.

In some implementations, wireless communications system 300 implements a 5G NR network. For example, wireless communications system 300 may include multiple 5G-capable network entities 340, 360, such as network entities (e.g., UEs, base stations) configured to operate in accordance with a 5G NR network protocol such as that defined by the 3GPP. In some other implementations, wireless communications system 300 implements a 6G network.

During operation of wireless communications system 300, network entity 340 transmits data signal 378 to network entity 360 and to tag device 120 via data channel 320, 322 (e.g., the first channel). Network entity 360 receives data included in data signal 378. Meanwhile, tag device 120 generates backscatter signal 380 based on data signal 378. Subsequently, tag device 120 transmits backscatter signal 380 via backscatter channel 324 (e.g., the second channel), which network entity 360 receives. Backscatter channel 324 may be distinct from data channel 320, 322. For example, backscatter channel 324 may be shifted in frequency relative to data channel 320 322. In some implementations, such as implementations in which network entity 340 corresponds to a base station or TRP and network entity 360 corresponds to a UE, data channel 320, 322 may be a physical downlink shared channel (PDSCH), and backscatter channel 324 may be a backscatter PDSCH. Conversely, in an implementation in which network entity 360 correspond to a base station or to a TRP and network entity 340 corresponds to a UE, data channel 320, 322 may be a physical uplink shared channel (PUSCH), and backscatter channel 324 may be a backscatter PUSCH.

Network entity 360 may be configured to generate positioning information 372 based on data signal 378 and backscatter signal 380. In particular, positioning information 372 may include a position measurement associated with a position of tag device 120, the position measurement based on data signal 378 and backscatter signal 380. For example, the position measurement may correspond to a ToA associated with backscatter signal 380. The ToA may correspond to a sum of a first quantity of time for data signal 378 to arrive at tag device 120 via data channel 322 and a second quantity of time for backscatter signal 380 to arrive at network entity 360 via backscatter channel 324 minus a group delay. The group delay may correspond to a third quantity of time for tag device 120 to generate backscatter signal 380 based on data signal 378. The group delay associated with tag device 120 may be included in tag information 368, which network entity 360 may receive from core network 130.

Network entity 360 may be configured to transmit a report 391 that includes or indicates positioning information 372. As above, positioning information 372 may include or indicate the position measurement. For instance, network entity 360 may be configured to transmit report 391 to core network 130. Core network 130 may be configured to receive report 391 and to store positioning information 372 in memory as positioning information 397. Core network 130 may be configured to identify a position of tag device 120 based on positioning information 397. For example, core network 130 may be configured to use techniques described with reference to FIG. 1 to determine a position of tag device based positioning information 397. In implementations, core network 130 may receive multiple reports, such as report 391, from other network entities (e.g., network entity 340), each report containing positioning information similar to positioning information 372. Accordingly, positioning information 397 may include positioning information received from a plurality of network entities. Core network 130 may be configured to identify the position of tag device 130 based on positioning information 397 received from the multiple network entities through application, by core network 130, of the positioning determination techniques described with reference to FIG. 1.

In some implementations, core network 130 may be configured to receive tag device indicator 370 from tag device 120. Tag device indicator 370 includes tag information 309, which may include or correspond to tag information 308, 368. Core network 130 may transmit tag information (e.g., tag information 309 received from tag device 120) to network entity 340, network entity 360, or both. Additionally, core network 130 may be configured to store tag information 309 in memory 392 as tag information 394. Since wireless communications system 300 may include a plurality of tag devices, such as tag device 120, tag information 394 may, in addition to tag information 309, also include tag information corresponding to other tag devices.

Network entity 340, 360 may be configured calibrate a positioning operation based on tag information 308, 368. For example, based on a sequence (e.g., a sequence specific to tag device 120), an identifier, a code, or other data of tag information 308 that uniquely identifies tag device 120, network entity 340 may be configured to generate tag device activation signal 382, which network entity 340 may transmit to tag device 120. Tag device activation signal 382 may configure tag device 120 to generate backscatter signal 380 in response to receipt, by tag device 120, of data signal 378. Since tag device activation signal 382 may be unique to tag device 120, transmission by network entity 340 of tag device activation signal 382 may be configured to activate tag device 120 but may not activate other tag devices within range of network entity 340. As another example, since tag information 368 may include a frequency of backscatter signal 380, a bandwidth of backscatter signal 380, or both, network entity 360 may search for backscatter signal 380 in the bandwidth or frequency range designated by tag information 368.

Additionally, in implementations, core network 130 may receive network entity indicator 383 from network entity 340, 360, or both. Network entity indicator 383 may include network entity information 385, indicating attributes associated with network entity 340, 360. For example, network entity information 385 associated with network entity 360 may indicate, to core network 130 (e.g., MF 131 of core network 130) a capability of network entity 360 to perform a positioning operation based on data signal 378 and backscatter signal 380, a location of network entity 360 relative to other devices (e.g., network entity 340, core network 130), or a combination thereof.

To generate the position measurement associated with the position of tag device 120, network entity 360 may apply channel parameters 371 associated with data channel 320, 322 to decode data included in data signal 378. Network entity 360 may determine a tag device position measurement associated with tag device 120 based on the decoded data. Channel parameters 371 associated with data channel 320, 322 may include a first value corresponding to a frequency of data channel 320, 322, a second value corresponding to a bandwidth of data channel 320, 322, a third value corresponding to a path loss of data channel 320, 322, a fourth value corresponding to a channel frequency response (CFR) of data channel 320, 322, a fifth value corresponding to a channel impulse response (CIR) of data channel 320, 322 or a combination thereof. In some implementations, network entity 340 may provide channel parameters 371 associated with data channel 320, 322 to network entity 360 prior to commencement of communication with network entity 360 (e.g., prior to transmitting data signal 378 to network entity 360). In other implementations, network entity 360 may estimate channel parameters 371 associated with data channel 320, 322 based on data signal 378.

Additionally, network entity 360 may determine channel parameters 371 associated with backscatter channel 324 based on decoding data included in data signal 378. Network entity 360 may apply channel parameters 371 associated with backscatter channel 324 to determine a tag device position estimation associated with the position of tag device 120. The tag device position estimation also may be referred to as a superpositioned backscatter channel estimation as explained and described with reference to FIG. 5. The tag device position estimation may include or correspond to an estimate of the position of tag device 120. Channel parameters 371 associated with backscatter channel 324 may include a first value corresponding to a frequency of backscatter channel 324, a second value corresponding to a bandwidth of backscatter channel 324, a third value corresponding to a path loss of backscatter channel 324, a fourth value corresponding to a channel frequency response (CFR) of backscatter channel 324, a fifth value corresponding to channel impulse response (CIR) of backscatter channel 324, or any combination thereof.

In some implementations, network entity 340 (e.g., a Tx TRP) and network entity 360 (e.g., an Rx UE), may be configured to identify a position of ambient Internet of Things (IoT) device, such as tag device 120. For instance, a position of tag device 120 within an environment may be unknown. However, a position, within the environment, of network 340, network entity 360, or both may be known. To illustrate, the position of network 340, network entity 360, or both may be known to core network 130.

During a communication session between network entity 340 and the network entity 360, network entity 340 may send a data signal, such as data signal 378, to network entity 360 and to tag device 120 via data channel 320, 322. Network entity 360 may receive a backscatter signal, such as backscatter signal 380, from tag device 120. Tag device 120 may generate backscatter signal 380 based on data signal 378 and may transmit backscatter signal 380 to network entity 360 on backscatter channel 324. Backscatter channel 324 may be shifted in frequency relative to the data channel 320, 322, but, otherwise, the data modulated onto data signal 378 may be the same as the data modulated onto backscatter signal 380.

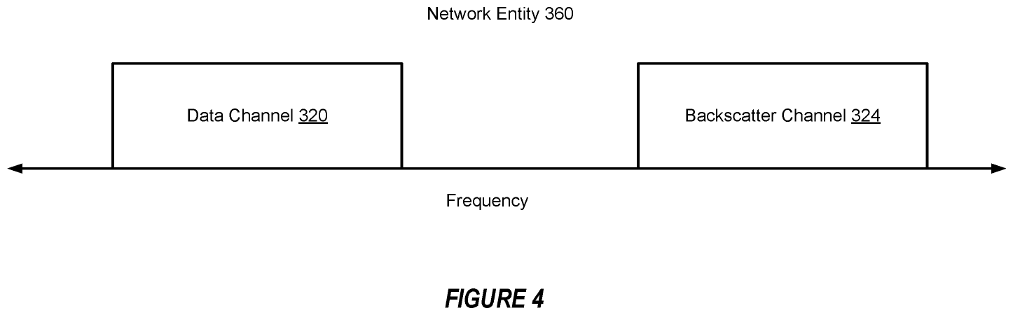

To illustrate and with reference to FIG. 4, which is a diagram illustrating backscatter based positioning according to one or more aspects, network entity 360, may receive data signal 378 on data channel 320 and may receive backscatter signal 380 on backscatter channel 324. As depicted in FIG. 4, backscatter channel 324 may be shifted in frequency relative to data channel 320. While FIG. 4 depicts that backscatter channel 324 is at a higher frequency than data channel 320, in some implementations, backscatter channel 324 may be at a lower frequency than data channel 320. Additionally, in some implementations, a bandwidth associated with data channel 320 may not overlap with a bandwidth associated with backscatter channel 324. In some implementations, channel parameters 310, 371 may indicate a bandwidth of backscatter channel 324. Accordingly, based on the expected bandwidth of backscatter channel 324, the Rx network entity, such as network entity 360, may search for backscatter signal 380 within the expected bandwidth allocated for backscatter channel 324.

In some implementations, network entity 360 (e.g., the Rx UE) may determine a ToA of data signal 378 and backscatter signal 380 based on channel estimation as explained with reference to FIG. 5. Referring to FIG. 5, FIG. 5 is a diagram illustrating backscatter based positioning according to one or more aspects. In some implementations, FIG. 5 indicates a processing flow performed by network entity 360. As depicted in FIG. 5, network entity 360 may store, in memory 364, channel parameters 371 associated with data channel 320, 322. For example, network entity 340 (e.g., the Tx TRP) may have provided channel parameters 371 associated with the data channel 320, 322 to network entity 360. Alternatively, network entity 360 might have estimated channel parameters 371 associated with the data channel 320, 322 based on receipt, by network entity 360, of data signal 376.

Network entity 360 may perform decoding 502 to decode data included in data signal 378 and transmitted via data channel 320, 322. For example, network entity 360 may apply channel parameters 371 associated with data channel 320, 322 to decode the data modulated onto data signal 378.

Based on decoding the data, the network entity 360 may perform channel estimation 506. Channel estimation 506 may include or correspond to estimating, by network entity 360, channel parameters 371 associated with backscatter channel 324. To illustrate, since the backscatter channel 324 is a frequency shifted version of data channel 320, 322 and since data modulated onto data signal 378 carried by data channel 320, 322 is the same as data modulated onto backscatter signal 380 carried by backscatter channel 324, decoding the data transmitted on data channel 320, 322 enables network entity 360 to estimate channel parameters 371 associated with backscatter channel 324. Accordingly, based on known channel parameters 371 associated with the data channel 320, 322 and estimated (or derived) channel parameters 371 associated with backscatter channel 324, network entity 360 may generate a superpositioned backscatter channel estimation 508. In particular, the superpositioned backscatter channel estimation 508 may include or correspond to a product of channel parameters 371 associated with data channel 320, 322 and channel parameters 371 associated with backscatter channel 324. Based on the superpositioned channel estimation 508, network entity 360 may determine a ToA associated with data signal 378 and backscatter signal 380. The ToA may correspond to a sum of a first quantity of time for data signal 378 to propagate to tag device 120 and a second quantity of time for backscatter signal 378 to propagate to network entity 360 from tag device 120 minus a group delay corresponding to a third quantity of time associated with generation, by tag device 120, of backscatter signal 380 based on data signal 378. Network entity 360 may then transmit the ToA measurement to a LMF, such as MF 131 of core network 130. For example, the ToA measurement may be included in positioning information 372 included in report 391 and transmitted, by network entity 360, to core network 130.

In some implementations, the core network, such as core network 130, receives a plurality of ToA measurements from a plurality of network entities. Based on these ToA measurements, the LMF may be configured to determine a position of tag device 120, as explained with reference to FIG. 1.

As described with reference to FIGS. 3-5, the present disclosure provides techniques for supporting backscatter based positioning. The techniques described reduce signaling overhead associated with performance of a positioning operation, thereby reducing computational resources, communication resources, power, or any combination thereof allocated to performing the positioning operation. To illustrate, in lieu of using a dedicated signal, such as a positioning reference signal (PRS), in a positioning operation, the disclosure deploys existing telecommunication data signals, such as data signal 378, to both implement a communication operation and a positioning operation. Accordingly, the computational overhead, such as processing capacity and memory, that otherwise would be dedicated to generating the dedicated PRS is liberated, and may be deployed for other purposes. Additionally, or alternatively, communication resources, such as frequency and time, that otherwise would be allocated to perform the positioning operation, are conserved. Further, power that otherwise would be allocated to generating and transmitting the dedicating PRS likewise is conserved. Accordingly, by conflating a communication operation with a positioning operation, resources are conserved.

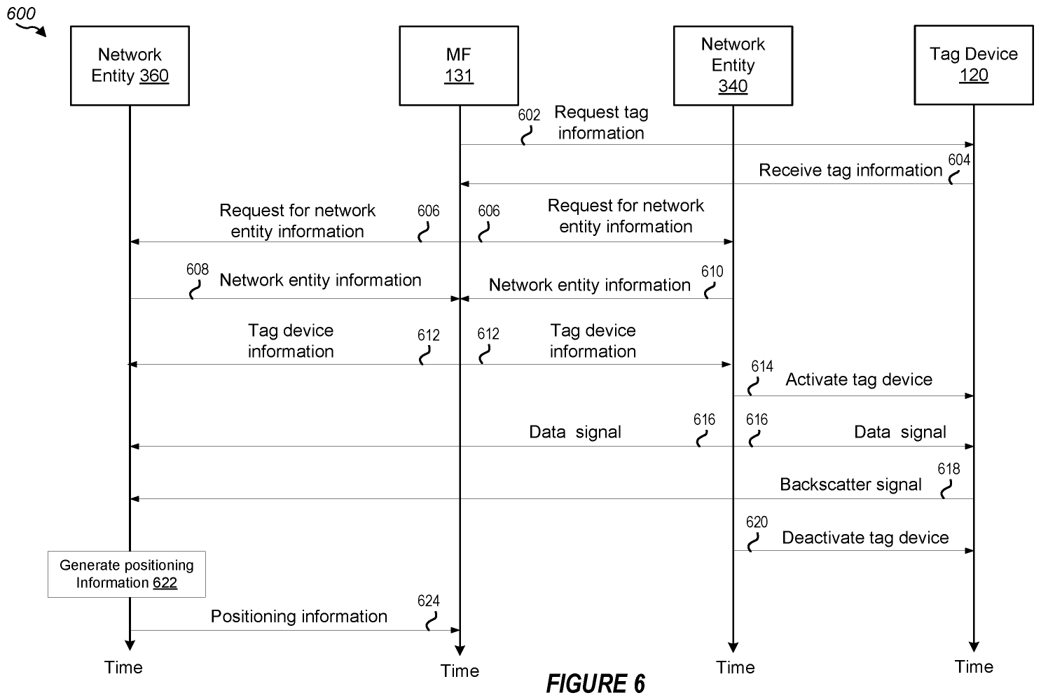

Referring to FIG. 6, FIG. 6 is a ladder diagram illustrating backscatter based positioning according to one or more aspects. As illustrated in FIG. 6, network entity 340 (e.g., a Tx network entity), network entity 360 (e.g., a Rx network entity), and MF 131 perform a positioning operation to identify a position of tag device 120.

At 602, MF 131 may request tag information from tag device 120. The tag information may include or correspond to tag device information 308, 309, 368, 394. The tag information may include or correspond to a sensitivity indicator that indicates a sensitivity of tag device 120 to data signal 378 transmitted by network entity 340, a group delay indicator that indicates a processing time incurred by tag device 120 to generate backscatter signal 380 based on data signal 378, capability information that indicates a capability of tag device 120 to shift a frequency of data signal 378 as explained with reference to FIG. 4, a tag identifier, a bandwidth of backscatter signal 378, or a combination thereof.

At 604, MF 131 may receive the tag information. For example, tag device 120 may send, to MF 131, tag device indicator 370 that includes or indicates tag information 309. In some implementations, MF 131 may receive the tag information in response to the request for tag information. MF 131 may store tag information in memory 392 as tag information 394.

At 606, MF 131 may transmit a request for network entity information to network entity 340, to network entity 360, or to both. Although shown as being sent at the same time, the request for network entity information at 606 may be transmitted at different times.

At 608 and 610, network entity 340 and network entity 360, respectively, may provide network entity information to MF 131. For example, network entity 340, 360 may transmit, to MF 131, network entity indicator 385 that includes or indicates network entity information 385. Although shown as being sent at the same time, the network entity information at 608 and 610 may be transmitted at different times. Network entity information 385 may include or indicate a location of network entity 340, 360, an address of network entity 340, 360, unique identifier associated with network entity 340, 360, a capability of network entity 340, 360 to support joint positioning and communication sessions, a capability of network entity 340, 360 to perform channel estimation as explained with reference to FIG. 5, or any combination thereof. While FIG. 6 depicts that MF 131 sends a request for network entity information to network entity 340 and 360, in some implementations, MF 131 may send the request for network entity information to one network entity and not to the other network entity.

At 612, MF 131 may disseminate the tag information to network entity 340, network entity 360, or both. For example, based on network entity information 385 received from network entity 340, network entity 360, or both, MF 131 may determine that network entity 340, network entity 360, or both are capable of performing a joint backscatter based positioning operation and a communication operation. Accordingly, MF 131 may transmit the tag information to network entity 340, network entity 360, or both. Although shown as being sent at the same time, the tag device information at 612 may be transmitted at different times. Network entity 340 may store the tag information as tag information 308, and network entity 360 may store the tag information at tag information 368.

At 614, network entity 340 may activate tag device 120. For example, network entity 340 may send tag device activation signal 382 to tag device 120, and tag device 120 may be configured to enter into an active state based on receipt of tag device activation signal 382. In an active state, tag device 120 may be configured to generate backscatter signal 380 based on data signal 378 received at tag device 120, while in an inactive state, tag device 120 may not generate backscatter signal 380 even in response to receipt of data signal 378. Network entity 340 may be configured to generate tag device activation signal 382 based on tag information 308. For example, tag information 308 may include a sequence, an identifier, a code, or the like that is unique to tag device 120. Accordingly, tag device activation signal 382 may be a unique tag-specific sequence (e.g., a sequence unique to tag device 120) that causes tag device 120 to transition into the active state.

In some implementations, network entity 340 transmits tag device activation signal 382 to tag device 120 outside data channel 320, 322 resource blocks (RBs), such as outside PDSCH allocated to RBs. For example, network entity 340 may transmit tag device activation signal 382 to tag device prior to transmitting data signal 378. However, in other implementations, network entity 340 transmits tag device activation signal 382 to tag device 120 within data channel 320, 322 allocated RBs, such as within PDSCH allocated RBs of data signal 378. Network entity 340 may apply the first implementation for passive tag devices, semi-passive tag devices, or both. In contrast, network entity 340 may apply the second implementation to semi-passive tag devices, active tag devices, or both.

At 616, network entity 340 transmits data signal 378 to network entity 340 and to tag device 120 via data channel 320, 322. For example, network entity 340 may broadcast data signal 374 on data channel 320, 322, and each of network entity 360 and tag device 120 may receive data signal 378.

At 618, tag device 120 transmits backscatter signal 380 to network entity 360. For example, tag device 120, being in an active mode in response to receipt of tag device activation signal 382 from network entity 340, may be configured to reflect the received data signal 378 as a backscatter signal 380. As explained with reference to FIG. 4, backscatter signal 380 may be shifted in frequency relative to a frequency of data signal 378 but, otherwise, the data modulated onto data signal 378 also is modulated onto backscatter signal 380.

At 620, network entity 340 may deactivate tag device 120. For example, network entity 340 may send tag device deactivation signal 384 to tag device 120, and tag device 120 may be configured to enter into an inactive state based on receipt of tag device deactivation signal 384. Tag device deactivation signal 384 may cause tag device 120 to transition from an active state to an inactive state. Moreover, network entity 340 may be configured to generate tag device deactivation signal 384 based on tag information 308. For example, tag information 308 may include a sequence, an identifier, a code, or the like that is unique to tag device 120. Accordingly, tag device deactivation signal 384 may be a unique tag-specific sequence (e.g., a sequence unique to tag device 120) that causes tag device 120 to transition into the inactive state.

In some implementation, network entity 340 transmits tag device deactivation signal 384 to tag device 120 outside data channel 320, 322 RBs, such as outside PDSCH allocated to RBs. However, in other implementations, network entity 340 transmits tag device deactivation signal 384 to tag device 120 within data channel 320, 322 allocated RBs, such as within PDSCH allocated RBs. Network entity 340 may apply the first implementation for passive tag devices, semi-passive tag devices, or both. In contrast, network entity 340 may apply the second implementation to semi-passive tag devices, active tag devices, or both.

At 622, network entity 360 generates positioning information, such as positioning information 312, 372, 397, based on data signal 378 and backscatter signal 380. As explained with reference to FIG. 5, network entity 378 may decode data modulated onto data signal 378 based on channel parameters 371 corresponding to data channel 320, 322. By decoding data modulated onto data signal 378, network entity 360 may be configured to estimate channel parameters 378 associated with backscatter channel 324. From the estimated channel parameters 378 associated with backscatter channel 324, network entity 360 may determine a superposition of data channel 322 and backscatter channel 324. From the superposition of data channel 322 and backscatter channel 324, network entity 360 may determine a ToA of data signal 378 and backscatter signal 380. Accordingly, positioning information 312, 372 may include or correspond to the ToA measurement. Network entity 360 may send positioning information 312, 372 (e.g. that includes the ToA measurement) to MF 131. MF 131 may store positioning information 312, 372 as positioning information 397. MF 131 may receive positioning information from other network devices and may, together with positioning information 397, determine a position of tag device 120.

It is understood that the timing of operations described with reference to FIG. 6 is merely an example and that the operations may occur at times other than those set forth in FIG. 6. For example, FIG. 6 depicts that MF 131 disseminates tag information 394 to network entity 340, network entity 360, or both after MF 131 requests network entity information 385 from network entity 340, network entity 360, or both. However, in some implementations, MF 131 may disseminate tag information 394 to network entity 340, network entity 360, or both prior to requesting network entity information 385. As another example, while FIG. 6 shows that MF 131 receives network entity information 385 from network entity 340 and network entity 360 simultaneously, MF 131 may receive network entity information from network entity 340 prior to or after MF 131 receives network entity information from network entity 360.

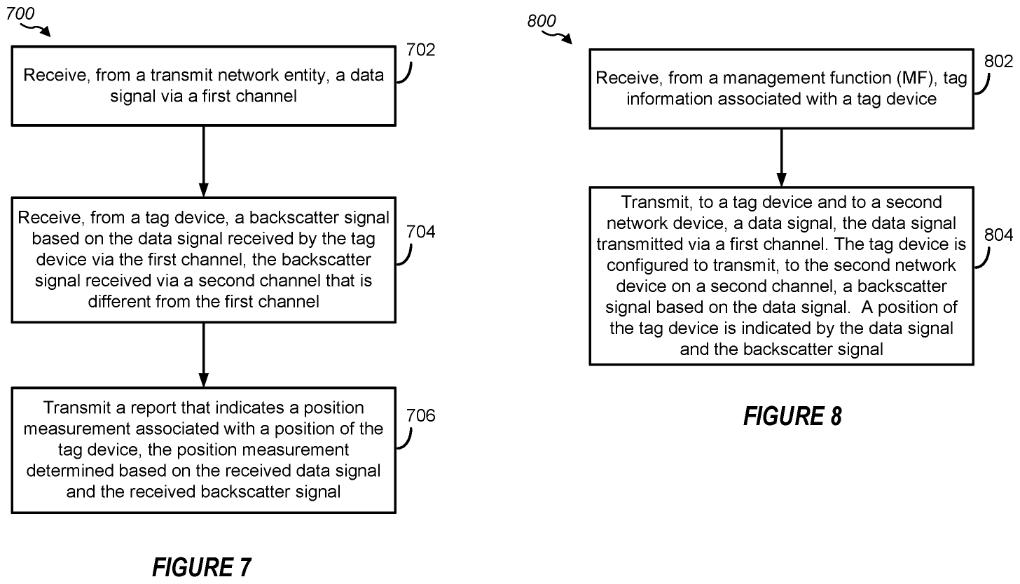

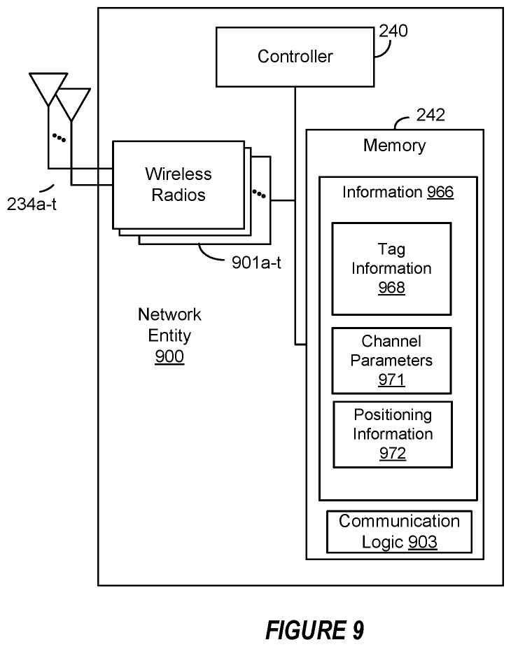

FIG. 7 is a flow diagram illustrating an example process 700 that supports backscatter based positioning according to one or more aspects. Operations of process 700 may be performed by a network entity, such as network entity 360, described above with reference to FIGS. 1 and 3-6 or network entity 900 described with reference to FIG. 9. For example, example operations (also referred to as “blocks”) of process 700 may enable network entity 360 to support backscatter based positioning.

In block 702, a network entity receives, from a transmit network entity, a data signal via a first channel. For example, network entity 360 receives, from transmit network entity 340, data signal 378 via data channel 320.

In block 704, the network entity receives, from a tag device, a backscatter signal based on the data signal received by the tag device via the first channel, the backscatter signal received via a second channel that is different from the first channel. For example, network entity 360 receives, from tag device 120, backscatter signal 380. Backscatter signal 380 is based on data signal 378 received by tag device 120 via data channel 322. Network entity 360 receives backscatter signal 380 via backscatter channel 324 that is different from data channel 322.

In block 706, the network entity transmits a report that indicates a position measurement associated with a position of the tag device. The position measurement is determined based on the received data signal and the received backscatter signal. For example, network entity 360 transmits report 391 that indicates positioning information 372 associated with a position of tag device 120. The positioning information 372 includes the position measurement. The positioning information 372 (e.g., including position measurement) is determined based on data signal 378 and backscatter signal 380 received at network entity 360.

In some implementations, the second channel is frequency shifted relative to a frequency of the first channel. For example, backscatter channel 324 is frequency shifted relative to a frequency of data channel 320, 322. As explained with reference to FIG. 4, a frequency of backscatter channel 324 may be higher than or lower than a frequency of data channel 320, 322. In some implementations, a bandwidth associated with data channel 320, 322 may not overlap a bandwidth associated with backscatter channel 324.

In some implementations, network entity 360 stores a first set of parameters associated with the first channel. For example, network entity 360 may store the first set of parameters, corresponding to channel parameters 371 associated with data channel 320, 322, in memory 364. The first set of parameters include a first value corresponding to a first frequency of the first channel, a second value corresponding to a first bandwidth of the first channel, a third value corresponding to a first path loss of the first channel, or a combination thereof. The first channel may include or correspond to data channel 320, 322. To elaborate, network entity 340 may transmit channel parameters 371 associated with data channel 320, 322 to network entity 360, which may store channel parameters 371 associated with data channel 320, 322 in memory 364. Accordingly, by receiving channel parameters 371 associated with data channel 320, 322 from network entity 340, network entity 360 may avoid having to estimate (e.g., compute) channel parameters 371 associated with data channel 320, 322, thereby conserving computational resources and power.

In some implementations, the network entity may estimate a first set of parameters associated with the first channel. For example, network entity 360 may estimate (e.g., calculate) channel parameters 371 associated with data channel 322, 324, such as based on data received in data signal 378. As above, the first set of parameters include a first value corresponding to a first frequency of the first channel (e.g., channel 320, 322), a second value corresponding to a first bandwidth of the first channel, a third value corresponding to a first path loss of the first channel, or a combination thereof.

In some implementations, the network entity may decode, based on a first set of parameters associated with the first channel, data included in the data signal. For example, network entity 360 may decode, based on channel parameters 371 associated with data channel 320, 322, data included in data signal 378. The first set of parameters include a first value corresponding to a first frequency of the first channel (e.g., channel 320, 322), a second value corresponding to a first bandwidth of the first channel, a third value corresponding to a first path loss of the first channel, or a combination thereof.

In some implementations, the network entity may determine a tag device position measurement estimation based on the decoded data. For example, network entity 360 may determine a tag device position measurement estimation of tag device 120 based on decoded data, as explained more fully with reference to FIGS. 5 and 6.

In some implementations, the network entity may determine a second set of parameters associated with the second channel based on decoding the data. For example, network entity 360 may determine channel parameters 371 associated with backscatter channel 324 based on decoding the data modulated on data signal 378 as explained more fully with reference to FIGS. 5 and 6.

In some implementations, to determine the tag device position measurement estimation, the network entity determines the tag device position measurement estimation based on the second set of parameters associated with the second channel. For example, network entity 360 may determine the tag device position measurement estimation based on channel parameters 371 associated with backscatter channel 324. The second set of parameters include a fourth value corresponding to a second frequency of the second channel (e.g., backscatter channel 324), a fifth value corresponding to a second bandwidth of the second channel, a sixth value corresponding to a second path loss of the second channel, or a combination thereof. The second frequency of the second channel is shifted in frequency relative to the first frequency of the first channel. For example, the frequency of backscatter channel 324 is shifted relative to a frequency of first channel 320, 322.

In some implementations, the receive network entity is one of a user equipment (UE) or a transmission reception point (TRP), and the transmit network entity is the other of the UE or the TRP. For example, network entity 360 (e.g., the receive network entity) may be a UE (e.g., UE 115) or a TRP, and the network entity 340 (e.g., the transmit network entity) may be the other of the UE or the TRP.

In some implementations, when the receive network entity is the UE, the first channel is a physical downlink shared channel (PDSCH) and the second channel is a backscatter PDSCH. For instance, when network entity 360 corresponds to a UE, such as UE 115, data channel 320, 322 corresponds to a PDSCH, and backscatter channel 324 corresponds to backscatter PDSCH.

In some implementations, when the receive network entity is the TRP, the first channel is a physical uplink shared channel (PUSCH) and the second channel is a backscatter PUSCH. For example, when network entity 360 corresponds to a TRP (or base station 105), data channel 320, 322 corresponds to a PUSCH, and backscatter channel 324 corresponds to a backscatter PUSCH.

In some implementations, the position measurement corresponds to a time of arrival (ToA) associated with the backscatter signal. For example, positioning information 372 that includes position measurement may include or correspond to a ToA associated with backscatter signal 380. In some implementations, the ToA corresponds to a sum of a first quantity of time for the data signal to arrive at the tag device via the first channel and a second quantity of time for the backscatter signal to arrive at the first network entity via the second channel minus a group delay. For instance, the ToA may include or correspond to a sum of a first quantity of time for data signal 378 to arrive at tag device 120 via data channel 320, 322 and a second quantity of time for backscatter signal 380 to arrive at network entity 360 via backscatter channel 324 minus a group delay (e.g., associated with tag device 120).

In some implementations, the group delay corresponds to a third quantity of time for the tag device to generate the backscatter signal based on the data signal. For example, the group delay may include or correspond to a third quantity of time for tag device 120 to generate backscatter signal 380 based on data signal 378 (e.g., such as a processing time to process data signal 378).

FIG. 8 is a flow diagram illustrating an example process 800 that supports backscatter based positioning according to one or more aspects. Operations of process 800 may be performed by a network entity, such as network entity 340, described above with reference to FIGS. 1 and 3-6 or network entity 900 described with reference to FIG. 9. For example, example operations (also referred to as “blocks”) of process 800 may enable network entity 340 to support backscatter based positioning.

In block 802, a transmit network entity receives, from a management function (MF), tag information associated with a tag device. For example, network entity 340 receives, from MF 131 (e.g., an LMF), tag information 308 associated with tag device 120.

In block 804, the transmit network entity transmits, to a tag device and to a second network device, a data signal, the data signal transmitted via a first channel. The tag device is configured to transmit, to the second network device on a second channel, a backscatter signal based on the data signal. A position of the tag device is indicated by the data signal and the backscatter signal. For example, network entity 340 transmits, to tag device 120 and to network entity 360 (e.g., a receive network entity), data signal 378 via data channel 320, 322. Tag device 120 is configured to transmit, to network entity 360 (e.g., a receive network entity) on backscatter channel 324, backscatter signal 380, which is based on data signal 378. A position of tag device 120 is indicted by data signal 378 and backscatter signal 378.

In some implementations, the tag information indicates a sequence that is unique to the tag device. For example, tag information 308 may indicate a sequence, an identifier, a code, etc. that uniquely identifies tag device 120. In some implementations, the second channel (e.g., backscatter channel 324) is shifted in frequency relative to a frequency of first channel (e.g., data channel 320, 322).

In some implementations, the transmit network entity transmits, to the tag device, a tag device activation signal based on the sequence. For example, network entity 340 may transmit, to tag device 120, tag device activation signal 382, and tag device activation signal 382 may be based on a sequence or unique identifier associated with tag device 120 and that is included in tag information 308.

In some implementations, based on receipt of the tag device activation signal, the tag device is configured to transmit the backscatter signal based on the data signal For instance, based on receipt of tag device activation signal 382, tag device 120 is configured to transmit backscatter signal 380 based on data signal 378.

In some implementations, to transmit the tag device activation signal, the transmit network entity transmits the tag device activation signal on the first channel. For instance, network entity 340 may transmit tag device activation signal 382 (e.g., to tag device 120) on data channel 322.

In some implementations, one or more resource blocks (RBs) of the first channel are allocated to encode the tag device activation signal. For example, one or more RBs of data channel 322 may be allocated to encode tag device activation signal 382.

In some implementations, the tag device is an active tag device. For example, tag device 120 may be an active tag device (e.g., as opposed to a passive or semi-passive tag device) as described with reference to FIG. 1.

In some implementations, to transmit the tag device activation signal, the transmit network entity transmits the tag device activation signal on a third channel. For example, network entity 340 may transmit tag device activation signal 382 on a channel other than data channel 320, 322. In particular, network entity 340 may transmit tag device activation signal 382 on a channel prior to transmitting data signal 378 on data channel 320, 322.

In some implementations, the tag device is a passive tag device or a semi-passive tag device. For instance, tag device 120 may be a passive tag device or a semi-passive tag device as described with reference to FIG. 1.

In some implementations, the transmit network entity may transmit, to the tag device, a tag device deactivation signal based on the sequence. For instance, network entity 340 may transmit, to tag device 120, tag device deactivation signal 384. Tag device deactivation signal 384 may be based on a sequence or unique identifier of tag device 120.

In some implementations, based on receipt of the tag device deactivation signal, the tag device is configured to deactivate a backscatter functionality. For example, based on receipt, by tag device 120, of tag device deactivation signal 384, tag device 120 may be configured to deactivate a backscatter functionality. By deactivating the backscatter functionality, tag device 120 may not generate backscatter signal 380 even when tag device 120 receives data signal 378.

In some implementations, to transmit the tag device deactivation signal, the transmit network entity transmits the tag device deactivation signal on the first channel. For instance, network entity 340 may transmit tag device deactivation signal 384 on data channel 320, 322.

In some implementations, one or more resource blocks (RBs) of the first channel are allocated to encode the tag device deactivation signal. For example, one or more RBs of data channel 320, 322 may be allocated to encode tag device deactivation signal 384.

In some implementations, to transmit the tag device deactivation signal, the transmit network entity transmits the tag device deactivation signal on a third channel. For instance, network entity 340 may transmit tag device deactivation signal 384 on a channel other than data channel 320, 322. In some implementations, the tag device deactivation signal (e.g., tag device deactivation signal 384) is transmitted after transmission of data signal 378 on data channel 320, 322.

FIG. 9 is a block diagram of an example network entity 900 that supports backscatter based positioning according to one or more aspects. Network entity 900 may correspond to network entity 340, 360. Network entity 900 may be configured to perform operations, including the blocks of a process described with reference to FIGS. 7 and 8. In some implementations, network entity 900 includes the structure, hardware, and components shown and described with reference to base station 105 or UE 115 of FIGS. 1-2. For example, network entity 900 includes controller 240, which operates to execute logic or computer instructions stored in memory 242, as well as controlling the components of network entity 900 that provide the features and functionality of network entity 900. Network entity 900, under control of controller 240, transmits and receives signals via wireless radios 901a-t and antennas 234a-t. Wireless radios 901a-t include various components and hardware, as illustrated in FIG. 2 for base station 105 or UE 115, including modulator and demodulators 254a-r, MIMO detector 256, receive processor 258, transmit processor 264, and TX MIMO processor 266.

As shown, memory 242 may include information 966 and communication logic 903. Information 966 may include or correspond to information 306, 366. Tag information 968, channel parameters 971, and positioning information 972 may include or correspond to tag information 308, 368, channel parameters 310, 371, and positioning information 312, 372, respectively. Communication logic 903 may be configured to enable communication between network entity 900 and one or more other devices. Network entity 900 may receive signals from or transmit signals to one or more devices, such as core network 130 (or MF 131) of FIG. 1, 3, or 6 or core network as illustrated in FIG. 11.

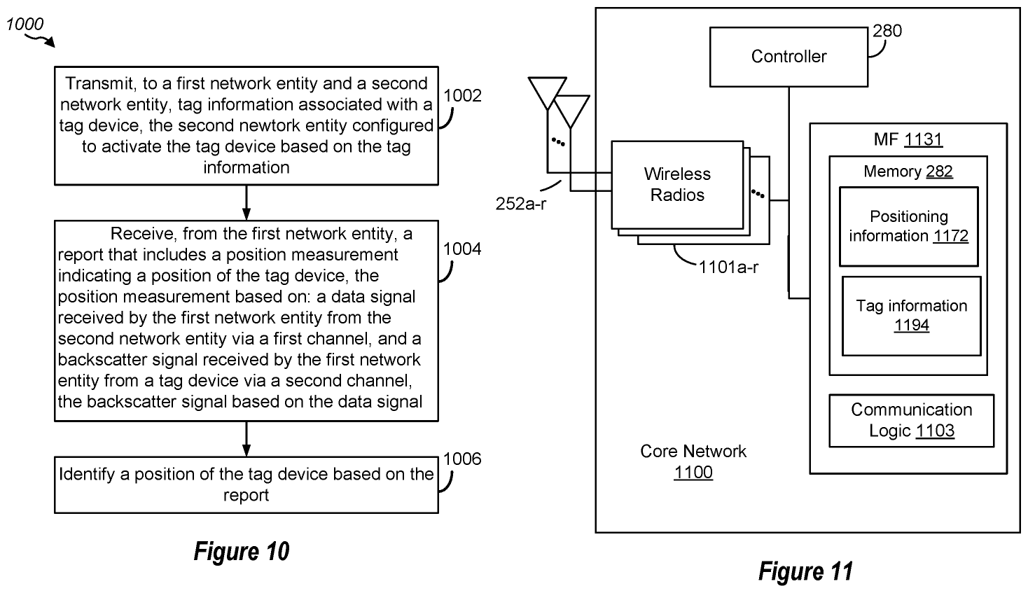

FIG. 10 is a flow diagram illustrating an example process 1000 that supports backscatter based positioning according to one or more aspects. Operations of process 1000 may be performed by a core network, such as core network 130 described with reference to FIGS. 1 and 3-6 or a core network as described with reference to FIG. 11. For example, example operations of process 1000 may enable core network 130 to support backscatter based positioning.

In block 1002, a management function (MF), such as a location management function (LMF) of a core network, transmits, to a first network entity and a second network entity, tag information associated with a tag device, the second network entity configured to activate the tag device based on the tag information. For example, MF 131 of core network 130 may transmit, to network entity 340 and to network entity 360, tag information 394 associated with tag device 120. Tag information 394 may correspond to tag information 308, 309, and 368. Network entity 340 (e.g., the second network entity) may be configured to activate tag device 120 based on tag information 308.

In block 1004, the MF receives, from the first network entity, a report that includes a position measurement indicating a position of the tag device. For example, MF 131 may receive, from network entity 360 (e.g., the first network entity) report 391 that includes positioning information 372. Positioning information 372 may include the position measurement indicating a position of tag device 120. The position measurement is based on a data signal received by the first network entity from the second network entity via a first channel, and a backscatter signal received by the first network entity from a tag device via a second channel, the backscatter signal based on the data signal. For example, positioning information 372 may be based on data signal 378 received by network entity 360 from network entity 340 via data channel 320, 322, and backscatter signal 380 received by network entity 360 from tag device 120 via backscatter channel 324. Backscatter signal 380 is based on data signal 378.

In block 1006, the MF identifies a position of the tag device based on the report. For example, MF 131 may identify a position of tag device 120 based on repot 391.

In some implementations, the MF receives a tag device indicator that indicates the tag information associated with the tag device. For example, MF 131 may receive tag device indicator 370 that includes or indicates tag information 309 associated with tag device 120.

In some implementations, the MF receives a first network entity indicator that indicates a first network entity information associated with a first network entity. For instance, MF 131 may receive network entity indicator 383 that indicates or includes network entity information 385. Network entity information 385 may be associated with network entity 360.

In some implementations, the first network entity information includes a capability of the first network entity to perform a positioning operation based on the data signal and based on the backscatter signal, a location of the first network entity, or a combination thereof. For example, network entity information 385 may include a capability of network entity 360 to perform a positioning operation based on data signal 378 and based on backscatter signal 380. Additionally, network entity information 385 may include or identify a location of network entity 360. While network entity indicator 383 and network entity information 385 are described with respect to network entity 360, it is understood that, in some implementations, network entity 340 may also transmit network entity indicator 383 to MF 131. Accordingly, network entity information 385 may include a capability of network entity 340 to perform a positioning operation based on data signal 378 and based on backscatter signal 380. Further network entity information 385 may include or identify a location of network entity 340.

In some implementations, the tag information includes a sensitivity indicator that indicates a sensitivity of the tag device to a data signal transmitted by the second network entity, a group delay indicator that indicates a processing time incurred by the tag device to generate a backscatter signal based on the data signal, capability information that indicates a capability of the tag device to shift a frequency of the data signal, a tag identifier, a bandwidth of the backscatter signal, or a combination thereof. For example, tag information 394 may include a sensitivity indicator that indicates a sensitivity of tag device 120 to data signal 378 transmitted by network entity 360. Additionally, tag information 394 may include a group delay indicator that indicates a processing time incurred by tag device 120 to generate backscatter signal 380 based on data signal 378. Further, tag information 394 may include capability information that indicates a capability of tag device 120 to shift a frequency of data signal 378. Moreover, tag information 394 may include a tag identifier. The tag identifier may uniquely identify tag device 120 (e.g., to electronically distinguish tag device 120 from other tag devices present in the environment). Additionally, tag information 394 may identify a bandwidth of backscatter signal 380. By identifying a bandwidth of backscatter signal 380, which, in some implementations, may not overlap with a bandwidth of data signal 378, network entity 360 may be configured to search for backscatter signal 380 within the designated bandwidth.

In some implementations, the first network entity includes a user equipment (UE) or a transmission reception point (TRP), and the second network entity includes to the other of the UE or the TRP. For example, network entity 360 may include or correspond to a UE (e.g., UE 115) or to a TRP, and network entity 340 may include or correspond to the other of the UE or to the TRP.

In some implementations, when the first network entity includes the UE, the first channel corresponds to a physical downlink shared channel (PDSCH), and the second channel corresponds to a PDSCH backscatter channel. For example, when network entity 360 includes or corresponds to the UE, data channel 320, 322 corresponds to a PDSCH, and backscatter channel 324 corresponds to a PDSCH backscatter channel.

In some implementations, when the first network entity includes to the TRP, the first channel corresponds to a physical uplink shared channel (PUSCH), and the second channel corresponds to a PUSCH backscatter channel. For example, when network entity 360 includes or corresponds to the TRP, data channel 320, 322 corresponds to a PUSCH, and backscatter channel 324 corresponds to a PUSCH backscatter channel.

FIG. 11 is a block diagram of an example core network 1100 that supports backscatter based positioning according to one or more aspects. Core network 1100 may be configured to perform operations, including the blocks of process 1000 described with reference to FIG. 10. In some implementations, core network 1000 includes the structure, hardware, and components shown and described with reference to core network 130 of FIGS. 1-3. Moreover, core network 130 may include certain structures that correspond to base station 105, UE 115, or both as described with reference to FIGS. 1 and 2. For example, core network 1100 may include controller 280, which operates to execute logic or computer instructions stored in memory 282, as well as controlling the components of core network 1100 that provide the features and functionality of core network 1100. Core network 1100, under control of controller 280, transmits and receives signals via wireless radios 1101a-r and antennas 252a-r. Wireless radios 1101a-r include various components and hardware, as illustrated in FIG. 2, including modulator and demodulators 232a-t, transmit processor 220, TX MIMO processor 230, MIMO detector 236, and receive processor 238.

As shown, memory 282 may include positioning information 1172, tag information 1194, and communication logic 1103. Positioning information 1172 may include or correspond to positioning information 397, and tag information 1194 may include or correspond to tag information 394. Communication logic 1103 may be configured to enable communication between core network 1100 and one or more other devices. Core network 1100 may receive signals from or transmit signals to one or more network entities, such as network entities 340, 360 of FIGS. 1, 3, 6, or network entity 900 of FIG. 9.

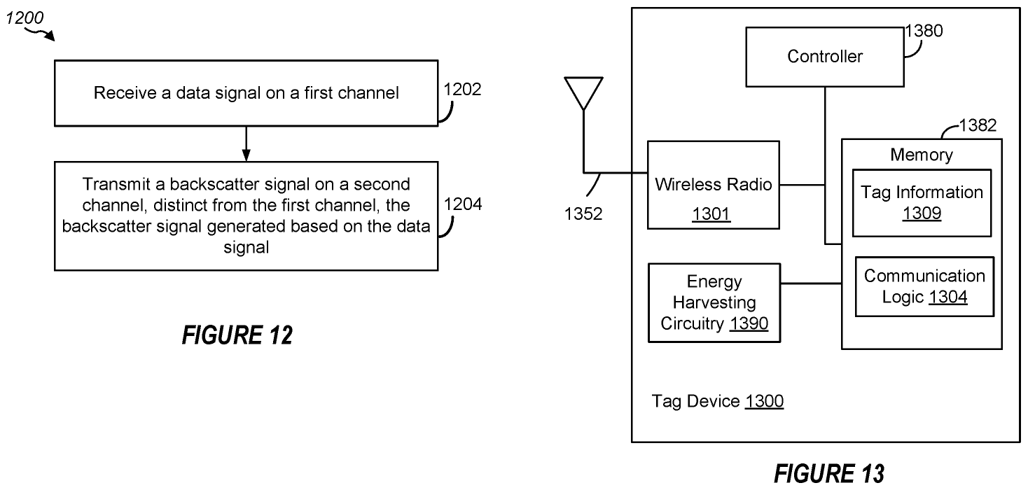

FIG. 12 is a flow diagram illustrating an example process 1200 that supports backscatter based positioning according to one or more aspects. Operations of process 1200 may be performed by a tag device, such as tag device 120 described with reference to FIGS. 1 and 3-6 or a tag device as described with reference to FIG. 13. For example, example operations of process 1200 may enable tag device 120 to support backscatter based positioning.

In bock 1202, the tag device may receive a data signal on a first channel. For example, tag device 120 may receive data signal 378 on data channel 322.

In block 1204, the tag device may transmit a backscatter signal on a second channel, distinct from the first channel, the backscatter signal generated based on the data signal. For example, tag device 120 may transmit backscatter signal 380 on backscatter channel 324. Backscatter channel 324 may be distinct from data channel 320, 322.

In some implementations, the tag device receives an activation signal on the first channel, the activation signal interspersed on resource blocks (RBs) of the first channel together with data included in the data signal. For example, tag device 120 may receive tag device activation signal 382 on data channel 322. The activation signal may be interspersed on RBs of data channel 322 together with data modulated onto data signal 378.

In some implementations, the tag device transmits the backscatter signal in response to receipt of the activation signal. For example, tag device 120 may transmit backscatter signal 380 in response to receipt of tag device activation signal 382.

In some implementations, the tag device receive a deactivation signal on a third channel distinct form the first channel and the second channel. For example, tag device 120 may receive tag device deactivation signal 384 on a third channel that is not data channel 320, 322.

In some implementations, the tag device may cease transmission of the backscatter signal in response to receipt of the deactivation signal. For example, tag device 120 may stop transmitting backscatter signal 380 in receipt to receipt of tag device deactivation signal 384 even while data signal 378 is being transmitted.

FIG. 13 is a block diagram of an example tag device 1300 that supports backscatter based positioning according to one or more aspects. Tag device 1300 may include or correspond to tag device 120. For example, tag device 1300 may include an RFID or IoT device. Additionally, or alternatively, tag device may include a passive device, a semi-passive device, or an active device.

Tag device 1300 may be configured to perform operations, including the blocks of a process described with reference to FIG. 12. In some implementations, tag device 1300 includes the structure, hardware, and components shown and described with reference to tag device 120. For example, tag device 1300 includes controller 1380, which operates to execute logic or computer instructions stored in memory 1382, as well as controlling the components of tag device 1300 that provide the features and functionality of tag device 1300. Controller 1380 and memory 1382 may include or correspond to circuitry 351. Tag device 1300, under control of controller 1380, is configured to transmit and receive signals via wireless radio 1301 and antenna 1352. In some implementations, wireless radio 1301 and antenna 1352 may include or correspond to transmitter 356, receiver 358, or a combination thereof. Wireless radio 1301 includes various components and hardware. As an illustrative, non-limiting example, tag device 1300 may include, as described with reference to FIG. 2, modulator and demodulators 254a-r, MIMO detector 256, receive processor 258, transmit processor 264, and TX MIMO processor 266.

Tag device 1300 also includes energy harvesting circuitry 1390. Energy harvesting circuitry 1390 may include or correspond to circuitry 351. Energy harvesting circuitry 1390 may include hardware (e.g., circuitry), software, or a combination thereof configured to harvest energy from an energy source for tag device 1300. For example, the energy source may include a solar energy source, a vibrational energy source, a thermal energy source, or an RF energy source, as illustrative, non-limiting examples. Energy harvesting circuitry 1390 may be coupled to circuitry, such as controller 1380, memory 1382, wireless radio 1301, a power source of tag device 1300, or a combination thereof. In some implementations, the harvested energy may be used to charge a power source, such as a battery or capacitor. The power source may be coupled to controller 1380, memory 1382, wireless radio 1301, or a combination thereof. Additionally, or alternatively, the harvested energy may be configured to power one or more components of tag device 1300.

As shown, memory 1382 may include tag information 1309 and communication logic 1304. Tag information 1309 may include or correspond to tag information 308, 309, 368. Communication logic 1304 may be configured to enable communication between tag device 1300 and one or more other devices. Tag device 1300 may be configured to receive signals from or transmit signals to one or more network entities, such as network entities 340, 360, and to core network, such as core network 130.

It is noted that one or more blocks (or operations) described with reference to FIGS. 5-8, 10, and 12 may be combined with one or more blocks (or operations) described with reference to another of the figures. For example, one or more blocks (or operations) of FIG. 7 may be combined with one or more blocks (or operations) of FIG. 8. As another example, one or more blocks associated with FIG. 7 may be combined with one or more blocks associated with FIG. 10 or 12. As another example, one or more blocks associated with FIG. 6 may be combined with one or more blocks associated with FIG. 5, 7, 8, 10 or 12. As another example, one or more blocks associated with FIGS. 7, 8, 10, and 12 may be combined with one or more blocks (or operations) associated with FIGS. 1-3. Additionally, or alternatively, one or more operations described above with reference to FIGS. 1-3 may be combined with one or more operations described with reference to FIG. 9, 11, or 13.

In one or more aspects, techniques for supporting backscatter based positioning may include additional aspects, such as any single aspect or any combination of aspects described below or in connection with one or more other processes or devices described elsewhere herein. In a first aspect, techniques for supporting backscatter based positioning may include receiving, from a transmit network entity, a data signal via a first channel. The techniques may further include receiving, from a tag device, a backscatter signal based on the data signal received by the tag device via the first channel, the backscatter signal received via a second channel that is different from the first channel; and transmitting a report that indicates a position measurement associated with a position of the tag device, the position measurement determined based on the received data signal and the received backscatter signal. In some examples, the techniques in the first aspect may be implemented in a method or process. In some other examples, the techniques of the first aspect may be implemented in a wireless communication device, which may include a network entity or a component of a network entity, a UE or a component of a UE, a TRP or a component of a TRP, or a base station or a component of a base station. For example, the techniques may include or correspond to a method of wireless communication performed by a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the second channel is frequency shifted relative to a frequency of the first channel.

In a third aspect, in combination with the first aspect or the second aspect, the techniques further include storing a first set of parameters associated with the first channel.

In a fourth aspect, in combination with the third aspect, the first set of parameters include a first value corresponding to a first frequency of the first channel, a second value corresponding to a first bandwidth of the first channel, a third value corresponding to a first path loss of the first channel, or a combination thereof.

In a fifth aspect, in combination with one or more of the first aspect through the fourth aspect, the techniques further include estimating a first set of parameters associated with the first channel.

In a sixth aspect, in combination with the fifth aspect, the first set of parameters include a first value corresponding to a first frequency of the first channel, a second value corresponding to a first bandwidth of the first channel, a third value corresponding to a first path loss of the first channel, or a combination thereof.

In a seventh aspect, in combination with one or more of the first aspect through the sixth aspect, the techniques further include decoding, based on a first set of parameters associated with the first channel, data included in the data signal.

In an eighth aspect, in combination with the seventh aspect, the first set of parameters include a first value corresponding to a first frequency of the first channel, a second value corresponding to a first bandwidth of the first channel, a third value corresponding to a first path loss of the first channel, or a combination thereof.

In a ninth aspect, in combination with the seventh aspect or the eighth aspect, the techniques include determining a tag device position measurement estimation based on the decoded data.

In a tenth aspect, in combination with the ninth aspect, the techniques further include determining a second set of parameters associated with the second channel based on decoding the data.

In an eleventh aspect, in combination with the tenth aspect, determining the tag device position measurement estimation further includes determining the tag device position measurement estimation based on the second set of parameters associated with the second channel.

In a twelfth aspect, in combination with the tenth aspect or the eleventh aspect, the second set of parameters include a fourth value corresponding to a second frequency of the second channel, a fifth value corresponding to a second bandwidth of the second channel, a sixth value corresponding to a second path loss of the second channel, or a combination thereof.

In a thirteenth aspect, in combination with one or more of the tenth aspect through the twelfth aspect, the second frequency of the second channel is shifted in frequency relative to the first frequency of the first channel.

In a fourteenth aspect, in combination with one or more of the first aspect through the thirteenth aspect, the receive network entity is one of a UE or a TRP, and the transmit network entity is the other of the UE or the TRP.

In a fifteenth aspect, in combination with the fourteenth aspect, when the receive network entity is the UE, the first channel is a PDSCH and the second channel is a backscatter PDSCH.

In a sixteenth aspect, in combination with the fourteenth aspect, when the receive network entity is the TRP, the first channel is a PUSCH and the second channel is a backscatter PUSCH.

In a seventeenth aspect, in combination with one or more of the first aspect through the sixteenth aspect, the position measurement corresponds to a ToA associated with the backscatter signal.

In an eighteen aspect, in combination with the seventeenth aspect, the ToA corresponds to a sum of a first quantity of time for the data signal to arrive at the tag device via the first channel and a second quantity of time for the backscatter signal to arrive at the receive network entity via the second channel minus a group delay.

In a nineteenth aspect, in combination with the eighteen aspect, the group delay corresponds to a third quantity of time for the tag device to generate the backscatter signal based on the data signal.

In one or more aspects, techniques for supporting backscatter positioning may include additional aspects, such as any single aspect or any combination of aspects described below or in connection with one or more other processes or devices described elsewhere herein. In a twentieth aspect, techniques for supporting backscatter based positioning may include transmitting, to a first network entity and a second network entity, tag information associated with a tag device, the second network entity configured to activate the tag device based on the tag information. The techniques may further include receiving, from the first network entity, a report that includes a position measurement indicating a position of the tag device. The position measurement is based on: a data signal received by the first network entity from the second network entity via a first channel, and a backscatter signal received by the first network entity from a tag device via a second channel, the backscatter signal based on the data signal. The techniques may further include identifying a position of the tag device based on the report. In some examples, the techniques in the twentieth aspect may be implemented in a method or process, such as a method to support one or more positioning operations performed by a network entity. In some other examples, the techniques of the twentieth aspect may be implemented in a network (e.g., a network device), such as a core network or a component of a core network, a management function (e.g., an LMF), or a base station or a component of a base station. In some examples, the network may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a communication interface) that includes a transmitter, a receiver, or a combination thereof. Additionally, or alternatively, the wireless communication device may include one or more means configured to perform operations described herein.

In a twenty-first aspect, in combination with the twentieth aspect, the tag information includes a sensitivity indicator that indicates a sensitivity of the tag device to a data signal transmitted by the second network entity, a group delay indicator that indicates a processing time incurred by the tag device to generate a backscatter signal based on the data signal, capability information that indicates a capability of the tag device to shift a frequency of the data signal, a tag identifier, a bandwidth of the backscatter signal, or a combination thereof.

In a twenty-second aspect, in combination with the twentieth aspect or the twenty-first aspect, the first network entity information includes a capability of the first network entity to perform a positioning operation based on the data signal and based on the backscatter signal, a location of the first network entity, or a combination thereof.

In a twenty-third aspect, in combination with one or more of the twentieth aspect through the twenty-second aspect, the first network entity includes a UE or a TRP, and wherein the second network entity includes to the other of the UE or the TRP.

In a twenty-fourth aspect, in combination with twenty-third aspect, when the first network entity includes the UE, the first channel corresponds to a PDSCH, and the second channel corresponds to a PDSCH backscatter channel.

In a twenty-fifth aspect, in combination with twenty-third aspect, when the first network entity includes to the TRP, the first channel corresponds to a PUSCH, and the second channel corresponds to a PUSCH backscatter channel.

In one or more aspects, techniques for supporting backscatter positioning may include additional aspects, such as any single aspect or any combination of aspects described below or in connection with one or more other processes or devices described elsewhere herein. In a twenty-sixth aspect, techniques for supporting backscatter based positioning may include receiving, from an LMF, tag information associated with a tag device. The techniques may further include transmitting, to a tag device and to a receive network entity, a data signal, the data signal transmitted via a first channel, and the tag device configured to transmit, to the receive network entity on a second channel, a backscatter signal based on the data signal. A position of the tag device is indicated by the data signal and the backscatter signal. In some examples, the techniques in the twentieth aspect may be implemented in a method or process, such as a method to support one or more positioning operations performed by a network entity. In some other examples, the techniques of the twentieth aspect may be implemented in a wireless communication device, such as a network entity, which may include a UE or a component of a UE, a TRP or a component of a TRP, or a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a twenty-seventh aspect, in combination with twenty-sixth aspect, the tag information indicates a sequence that is unique to the tag device, and wherein the second channel is shifted in frequency relative to a frequency of the first channel.

In a twenty-eighth aspect, in combination with the twenty-seventh aspect, the techniques further include transmitting, to the tag device, a tag device activation signal based on the sequence, wherein, based on receipt of the tag device activation signal, the tag device is configured to transmit the backscatter signal based on the data signal.

In a twenty-ninth aspect, in combination with the twenty-eighth aspect, transmitting the tag device activation signal includes transmitting the tag device activation signal on the first channel, wherein one or more RBs of the first channel are allocated to encode the tag device activation signal.

In a thirtieth aspect, in combination with the twenty-ninth aspect, the tag device is an active tag device.

In a thirty-first aspect, in combination with the twenty-ninth aspect, transmitting the tag device activation signal includes transmitting the tag device activation signal on a third channel, wherein the tag device activation signal is transmitted prior to transmission of the data signal on the first channel.

In a thirty-second aspect, in combination with the thirty-first aspect, the tag device is a passive tag device.

In a thirty-third aspect, in combination with the thirty-first aspect, the tag device is a semi-passive tag device.

In a thirty-fourth aspect, in combination with the twenty-ninth aspect, the techniques further include transmitting, to the tag device, a tag device deactivation signal based on the sequence.

In a thirty-fifth aspect, in combination with the thirty-fourth aspect, based on receipt of the tag device deactivation signal, the tag device is configured to deactivate a backscatter functionality.

In a thirty-sixth aspect, in combination with the thirty-fifth aspect, transmitting the tag device deactivation signal includes transmitting the tag device deactivation signal on the first channel.

In a thirty-seventh aspect, in combination with the thirty-sixth aspect, one or more RBs of the first channel are allocated to encode the tag device deactivation signal.

In a thirty-eighth aspect, in combination with the thirty-fifth aspect, transmitting the tag device deactivation signal includes transmitting the tag device deactivation signal on a third channel.

In a thirty-ninth aspect, in combination with the thirty-eighth aspect, the tag device deactivation signal is transmitted after transmission of the data signal on the first channel.

In one or more aspects, techniques for supporting backscatter positioning may include additional aspects, such as any single aspect or any combination of aspects described below or in connection with one or more other processes or devices described elsewhere herein. In a fortieth aspect, techniques for supporting backscatter based positioning may include receiving a data signal on a first channel. The techniques may further include transmitting a backscatter signal on a second channel, distinct from the first channel. The backscatter signal is generated based on the data signal. In some examples, the techniques in the fortieth aspect may be implemented in a method or process, such as a method to support one or more positioning operations performed by a network entity. In some other examples, the techniques of the twentieth aspect may be implemented in a wireless communication device, such as network entity, which may include a tag device or a component of a tag device. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a forty-first aspect, in combination with the fortieth aspect, the techniques further include receiving an activation signal on the first channel.

In a forty-second aspect, in combination with the forty-first aspect, the activation signal interspersed on RBs of the first channel together with data included in the data signal.

In a forty-third aspect, in combination with the forty-second aspect, the techniques further include transmitting the backscatter signal in response to receipt of the activation signal.

In a forty-fourth aspect, in combination with the fortieth aspect, the techniques further include receiving a deactivation signal on a third channel distinct from the first channel and the second channel.

In a forty-fifth aspect, in combination with the forty-fourth aspect, the techniques further include ceasing transmission of the backscatter signal in response to receipt of the deactivation signal.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-13 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A. B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method to support one or more positioning operations performed by a receive network entity, the method comprising:
receiving, from a transmit network entity, a data signal via a first channel;
receiving, from a tag device, a backscatter signal based on the data signal received by the tag device via the first channel, the backscatter signal received via a second channel that is different from the first channel; and
transmitting a report that indicates a position measurement associated with a position of the tag device, the position measurement determined based on the received data signal and the received backscatter signal.

2. The method of claim 1, wherein the second channel is frequency shifted relative to a frequency of the first channel.

3. The method of claim 1, further including:
storing a first set of parameters associated with the first channel, wherein the first set of parameters include a first value corresponding to a first frequency of the first channel, a second value corresponding to a first bandwidth of the first channel, a third value corresponding to a first path loss of the first channel, or a combination thereof.

4. The method of claim 1, further including:
estimating a first set of parameters associated with the first channel, wherein the first set of parameters include a first value corresponding to a first frequency of the first channel, a second value corresponding to a first bandwidth of the first channel, a third value corresponding to a first path loss of the first channel, or a combination thereof.

5. The method of claim 1, further including:
decoding, based on a first set of parameters associated with the first channel, data included in the data signal, wherein the first set of parameters include a first value corresponding to a first frequency of the first channel, a second value corresponding to a first bandwidth of the first channel, a third value corresponding to a first path loss of the first channel, or a combination thereof; and
determining a tag device position measurement estimation based on the decoded data.

6. The method of claim 5, further including:
determining a second set of parameters associated with the second channel based on decoding the data,
wherein:
determining the tag device position measurement estimation further includes determining the tag device position measurement estimation based on the second set of parameters associated with the second channel,
the second set of parameters include a fourth value corresponding to a second frequency of the second channel, a fifth value corresponding to a second bandwidth of the second channel, a sixth value corresponding to a second path loss of the second channel, or a combination thereof, and
the second frequency of the second channel is shifted in frequency relative to the first frequency of the first channel.

7. The method of claim 1, wherein the receive network entity is one of a user equipment (UE) or a transmission reception point (TRP), and the transmit network entity is the other of the UE or the TRP.

8. The method of claim 7, wherein, when the receive network entity is the UE, the first channel is a physical downlink shared channel (PDSCH) and the second channel is a backscatter PDSCH.

9. The method of claim 7, wherein, when the receive network entity is the TRP, the first channel is a physical uplink shared channel (PUSCH) and the second channel is a backscatter PUSCH.

10. The method of claim 1, wherein:
the position measurement corresponds to a time of arrival (ToA) associated with the backscatter signal, and
the ToA corresponds to a sum of a first quantity of time for the data signal to arrive at the tag device via the first channel and a second quantity of time for the backscatter signal to arrive at the receive network entity via the second channel minus a group delay.

11. The method of claim 10, wherein the group delay corresponds to a third quantity of time for the tag device to generate the backscatter signal based on the data signal.

12. A method to support one or more positioning operations performed by a location management function (LMF), the method comprising:
transmitting, to a first network entity and a second network entity, tag information associated with a tag device, the second network entity configured to activate the tag device based on the tag information;
receiving, from the first network entity, a report that includes a position measurement indicating a position of the tag device, the position measurement based on:
a data signal received by the first network entity from the second network entity via a first channel, and
a backscatter signal received by the first network entity from a tag device via a second channel, the backscatter signal based on the data signal; and
identifying a position of the tag device based on the report.

13. The method of claim 12, wherein the tag information includes a sensitivity indicator that indicates a sensitivity of the tag device to a data signal transmitted by the second network entity, a group delay indicator that indicates a processing time incurred by the tag device to generate a backscatter signal based on the data signal, capability information that indicates a capability of the tag device to shift a frequency of the data signal, a tag identifier, a bandwidth of the backscatter signal, or a combination thereof.

14. The method of claim 12, wherein the first network entity information includes a capability of the first network entity to perform a positioning operation based on the data signal and based on the backscatter signal, a location of the first network entity, or a combination thereof.

15. The method of claim 12, wherein the first network entity includes a user equipment (UE) or a transmission reception point (TRP), and wherein the second network entity includes to the other of the UE or the TRP.

16. The method of claim 15, wherein, when the first network entity includes the UE, the first channel corresponds to a physical downlink shared channel (PDSCH), and the second channel corresponds to a PDSCH backscatter channel.

17. The method of claim 15, wherein, when the first network entity includes to the TRP, the first channel corresponds to a physical uplink shared channel (PUSCH), and the second channel corresponds to a PUSCH backscatter channel.

18. A method to support one or more positioning operations performed by a transmit network entity, the method comprising:
receiving, from a location management function (LMF), tag information associated with a tag device; and
transmitting, to a tag device and to a receive network entity, a data signal, the data signal transmitted via a first channel, and the tag device configured to transmit, to the receive network entity on a second channel, a backscatter signal based on the data signal, and
wherein a position of the tag device is indicated by the data signal and the backscatter signal.

19. The method of claim 18, wherein the tag information indicates a sequence that is unique to the tag device, and wherein the second channel is shifted in frequency relative to a frequency of the first channel.

20. The method of claim 19, further including:
transmitting, to the tag device, a tag device activation signal based on the sequence, wherein, based on receipt of the tag device activation signal, the tag device is configured to transmit the backscatter signal based on the data signal.

21. The method of claim 20, wherein transmitting the tag device activation signal includes transmitting the tag device activation signal on the first channel, wherein one or more resource blocks (RBs) of the first channel are allocated to encode the tag device activation signal.

22. The method of claim 21, wherein the tag device is an active tag device.

23. The method of claim 21, wherein transmitting the tag device activation signal includes transmitting the tag device activation signal on a third channel, wherein the tag device activation signal is transmitted prior to transmission of the data signal on the first channel.

24. The method of claim 23, wherein the tag device is a passive tag device or a semi-passive tag device.

25. The method of claim 21, further including:
transmitting, to the tag device, a tag device deactivation signal based on the sequence, wherein, based on receipt of the tag device deactivation signal, the tag device is configured to deactivate a backscatter functionality.

26. The method of claim 25, wherein transmitting the tag device deactivation signal includes transmitting the tag device deactivation signal on the first channel, and wherein one or more resource blocks (RBs) of the first channel are allocated to encode the tag device deactivation signal.

27. The method of claim 25, wherein transmitting the tag device deactivation signal includes transmitting the tag device deactivation signal on a third channel, wherein the tag device deactivation signal is transmitted after transmission of the data signal on the first channel.

28. A method to support one or more positioning operations performed by a tag device, the method comprising:
receiving a data signal on a first channel; and
transmitting a backscatter signal on a second channel, distinct from the first channel, wherein the backscatter signal is generated based on the data signal.

29. The method of claim 28, further comprising:
receiving an activation signal on the first channel, the activation signal interspersed on resource blocks (RBs) of the first channel together with data included in the data signal; and
transmitting the backscatter signal in response to receipt of the activation signal.

30. The method of claim 28, further comprising:
receiving a deactivation signal on a third channel distinct from the first channel and the second channel; and
ceasing transmission of the backscatter signal in response to receipt of the deactivation signal.
